(19) United States
(12) Patent Application Publication
(10) Pub. No.: US 2026/0080299 A1
(43) Pub. Date: Mar. 19, 2026

(54) DISPLAY MANAGEMENT MODELING BASED ON USER BIOMETRICS

(71) Applicant: Google LLC, Mountain View, CA (US)

(72) Inventors: Shiblee Hasan, Santa Clara, CA (US); David Meisenholder, Playa Vista, CA (US)

(21) Appl. No.: 18/886,205

(22) Filed: Sep. 16, 2024

(51) Int. Cl. G06N 20/00

(52) U.S. Cl. CPC G06N 20/00

(57) ABSTRACT

Display management modeling based on user biometrics is described herein. In one implementation, a device sets a display parameter used to display visual content to a user. The display parameter is set to a first value determined using a machine learning model in response to an occurrence of a condition associated with a context in which the device displays the visual content. In association with the setting of the display parameter to the first value, biometric data from the user is detected as the device displays the visual content to the user. Based on this biometric data from the user, the machine learning model is updated. Then, in response to a reoccurrence of the condition, the display parameter is set to a second value that is different from the first value and is determined using the updated machine learning model. Corresponding methods, systems, and media are also disclosed.

### BACKGROUND

When people experience certain events, emotions, mental states, and so forth, these experiences may be accompanied by mental and psychological awareness of the situation, as well as, in certain cases, physiological manifestations within the body (separate from the mind). Certain such physiological phenomena may present in the person as biometric indications that may be detected using physical sensors. For example, electroencephalography (EEG) sensors, electromyography (EMG) sensors, eye tracking cameras, heart rate sensors, body temperature thermometers, and other sensors and devices may be used to detect various types of biometric data from people who wish to know, analyze, or use their biometric data for various purposes.

### SUMMARY

This disclosure relates to novel ways that computing devices may determine and make use of biometric data detected from users of the devices.

First, with any type of electronic display, different conditions and circumstances call for different behaviors and characteristics from the display. For example, a brighter display may be used to present content when ambient conditions are bright (e.g., such as outdoors during daytime hours) than when ambient conditions are dark (e.g., such as at nighttime or in a dimly-lit room). While manual display management can be performed by a user willing to seek out and change display settings in accordance with the current situation, this may not be particularly convenient or feasible, at least for certain types of displays when a continually high standard of quality is desired. For example, constant changes to various display parameters may be appropriate for a see-through display or other head-mounted display integrated with an extended reality presentation device. Accordingly, methods and systems described herein provide automatic and hybrid (automatic/manual) display management solutions based on real-time user biometrics captured using sensors described herein. More particularly, machine learning models may be trained with default values to provide effective display management for various conditions, and these models may then be customized and fine-tuned to individual users in the field using implementations described herein. In this way, display parameters for a device such as an extended reality device with a head-mounted display may be efficiently and effectively managed to provide a consistent and high-quality viewing experience for the user.

To this end, one example implementation described herein involves a method including: 1) setting a display parameter to a first value, the display parameter being used by a device to display visual content to a user, the first value being determined using a machine learning model in response to an occurrence of a condition associated with a context in which the device displays the visual content; 2) detecting, in association with the setting of the display parameter to the first value, biometric data from the user as the device displays the visual content to the user; 3) updating, based on the biometric data from the user, the machine learning model; and 4) setting the display parameter to a second value different from the first value, the second value being determined using the updated machine learning model in response to a reoccurrence of the condition.

Another example implementation described herein involves an extended reality display device including: 1) a head-mounted display configured to display visual content to a user based on a display parameter; 2) a biometric sensor configured to detect biometric data from the user as the head-mounted display displays the visual content to the user; 3) a memory storing instructions; and 4) one or more processors configured to execute the instructions to perform a process. The process in this example may be performed by: 1) setting the display parameter to a first value determined using a machine learning model in response to an occurrence of a condition associated with a context in which the head-mounted display displays the visual content; 2) detecting, in association with the setting of the display parameter to the first value, the biometric data from the user; 3) updating, based on the biometric data, the machine learning model; and 4) setting the display parameter to a second value different from the first value, the second value being determined using the updated machine learning model in response to a reoccurrence of the condition.

Yet another example implementation described herein involves a non-transitory computer-readable medium storing instructions that, when executed, cause one or more processors of a device to perform a process including: 1) setting a display parameter to a first value, the display parameter being used by the device to display visual content to a user, the first value being determined using a machine learning model in response to an occurrence of a condition associated with a context in which the device displays the visual content; 2) detecting, in association with the setting of the display parameter to the first value, biometric data from the user as the device displays the visual content to the user; 3) updating, based on the biometric data from the user, the machine learning model; and 4) setting the display parameter to a second value different from the first value, the second value being determined using the updated machine learning model in response to a reoccurrence of the condition.

Second, certain biometric data may be used to trigger actions to be performed on a device without other manual user input, whether those actions relate to changing display parameters (as described above) or to various other aspects of the device's function. In some cases, however, the device on which an action is to be triggered may be distinct from the device that is being used to capture the biometric data. For example, augmented reality glasses worn on a user's head may be well-situated to detect electroencephalography data and/or eye tracking data from the user, while a smartwatch on the user's wrist or a television across the room may be the device for which an action is desired to be triggered based on the detected biometric data. Accordingly, methods and systems for biometric data usage by interconnected devices are also described herein, along with a variety of examples of how biometric data detected by one device may be used to achieve useful functions on other, interconnected devices that are also used by the user.

To this end, one example implementation described herein involves a method including: 1) presenting, by a first device, content to a user of the first device; 2) receiving, by the first device from a second device communicatively coupled to the first device, biometric data detected from the user by the second device in association with the presenting of the content to the user; and 3) based on the biometric data, changing the presenting of the content to the user by the first device.

Another example implementation described herein involves a system including: 1) a first device configured to present content to a user and to receive biometric data detected from the user in association with the content being presented to the user; and 2) a second device communicatively coupled to the first device and configured to detect the biometric data and provide the biometric data to the first device. In this example, the first device is configured to change how the content is presented to the user based on the received biometric data.

Yet another example implementation described herein involves a non-transitory computer-readable medium storing instructions that, when executed, cause a processor of a first device to perform a process including: 1) presenting content to a user of the first device; 2) receiving, from a second device communicatively coupled to the first device, biometric data detected from the user by the second device in association with the presenting of the content to the user; and 3) changing the presenting of the content to the user based on the biometric data.

Various additional components and/or operations may be added to these systems and processes as may serve a particular implementation, examples of which will be described in more detail below. Additionally, it will be understood that each of the different types of implementations described in the examples above (i.e., methods, devices, and the non-transitory computer readable media) may additionally or alternatively be performed by other types of implementations as well. For example, a process described above as being encoded in a computer readable medium could be performed as a method or could be performed by one or more processors of a device. Similarly, a method set forth above could be encoded in instructions stored by a computer-readable medium or stored within the memory of a device, and so forth.

The details of these and other implementations are set forth in the accompanying drawings and the description below. Other features will also be made apparent from the following description, drawings, and claims.

### BRIEF DESCRIPTION OF THE DRA WINGS

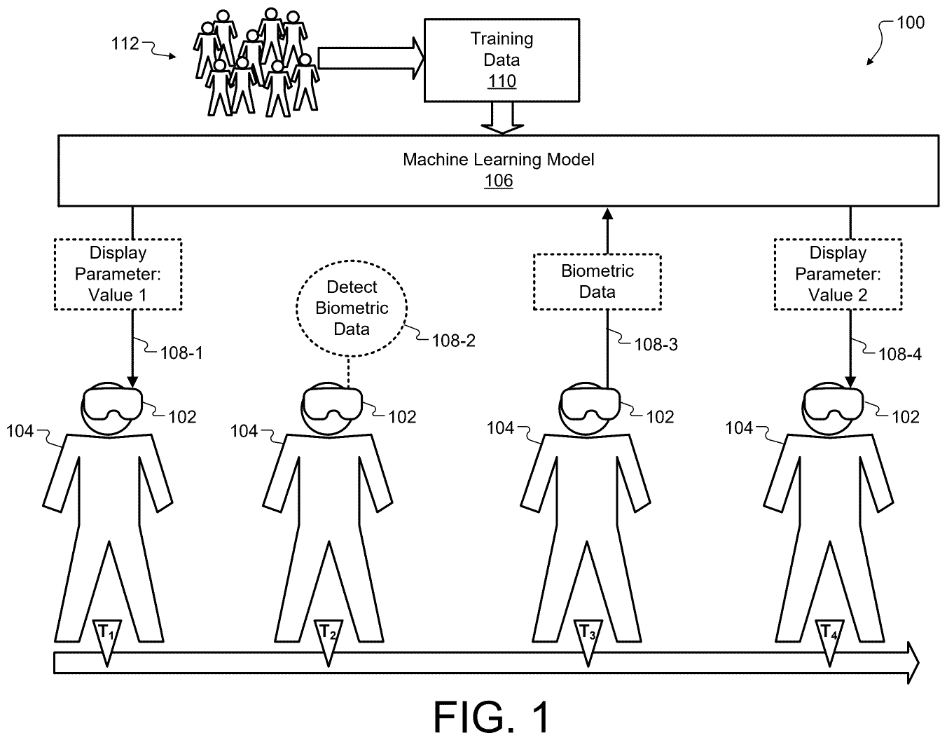

FIG. 1 shows certain aspects of an illustrative implementation of display management modeling based on user biometrics in accordance with principles described herein.

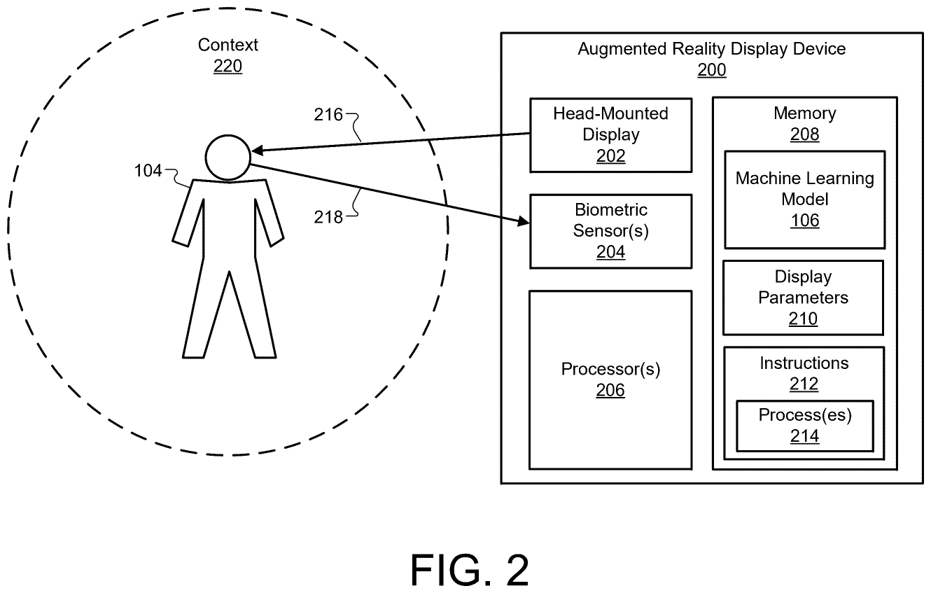

FIG. 2 shows an illustrative display device for display management modeling for different contexts and based on user biometrics in accordance with principles described herein.

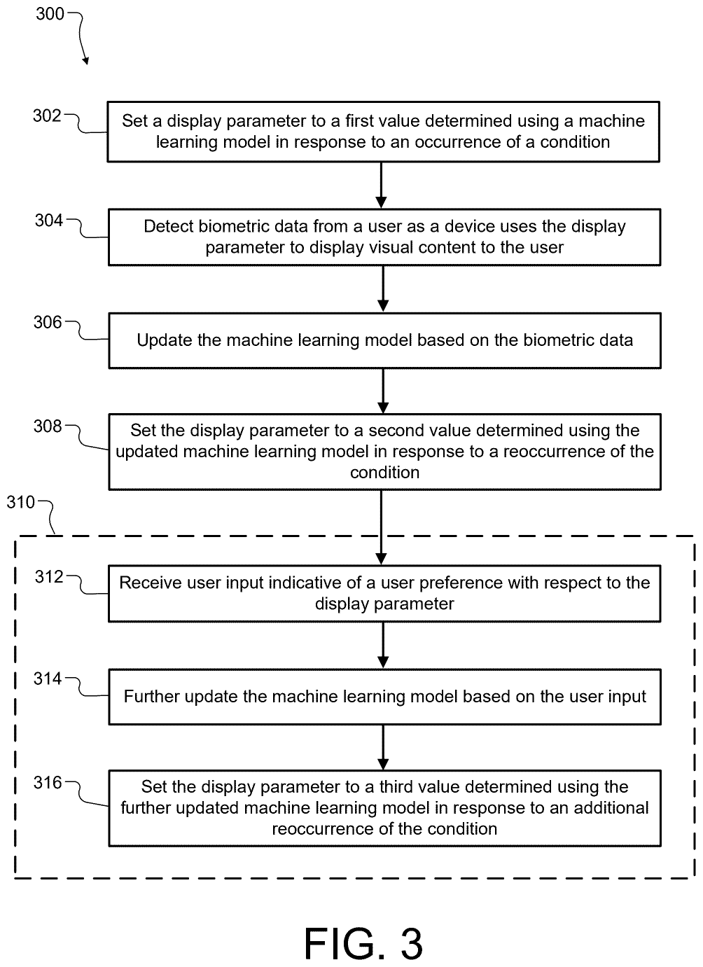

FIG. 3 shows an illustrative method for display management modeling based on user biometrics in accordance with principles described herein.

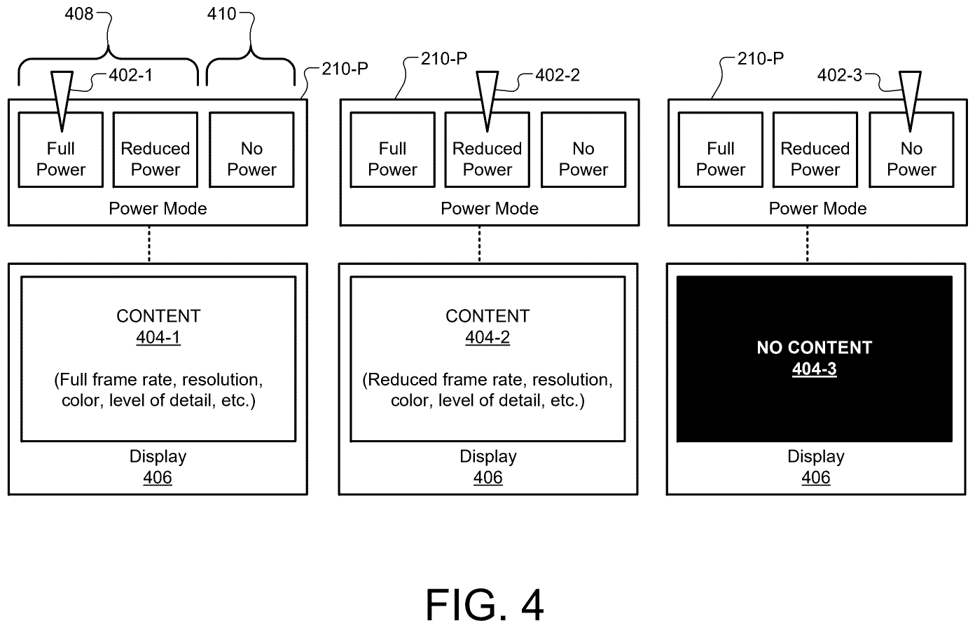

FIG. 4 shows illustrative aspects relating to setting and using a first display parameter to display visual content to a user in accordance with principles described herein.

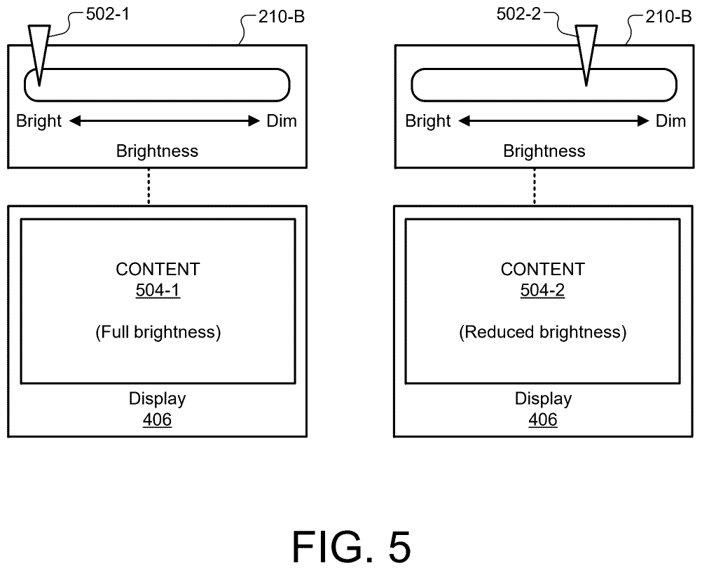

FIG. 5 shows illustrative aspects relating to setting and using a second display parameter to display visual content to a user in accordance with principles described herein.

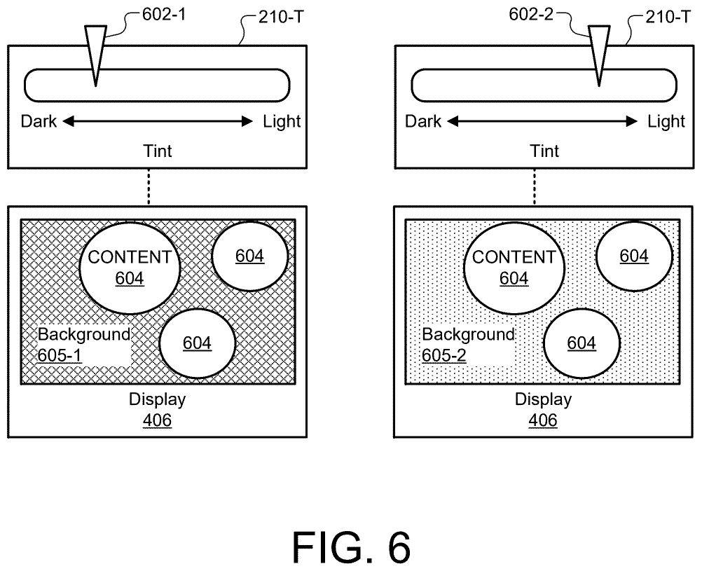

FIG. 6 shows illustrative aspects relating to setting and using a third display parameter to display visual content to a user in accordance with principles described herein.

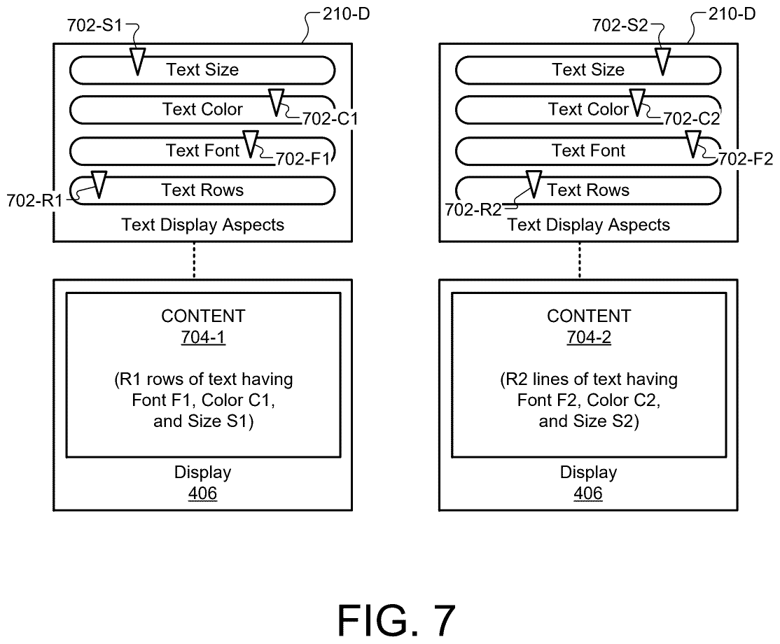

FIG. 7 shows illustrative aspects relating to setting and using various additional display parameters to display visual content to a user in accordance with principles described herein.

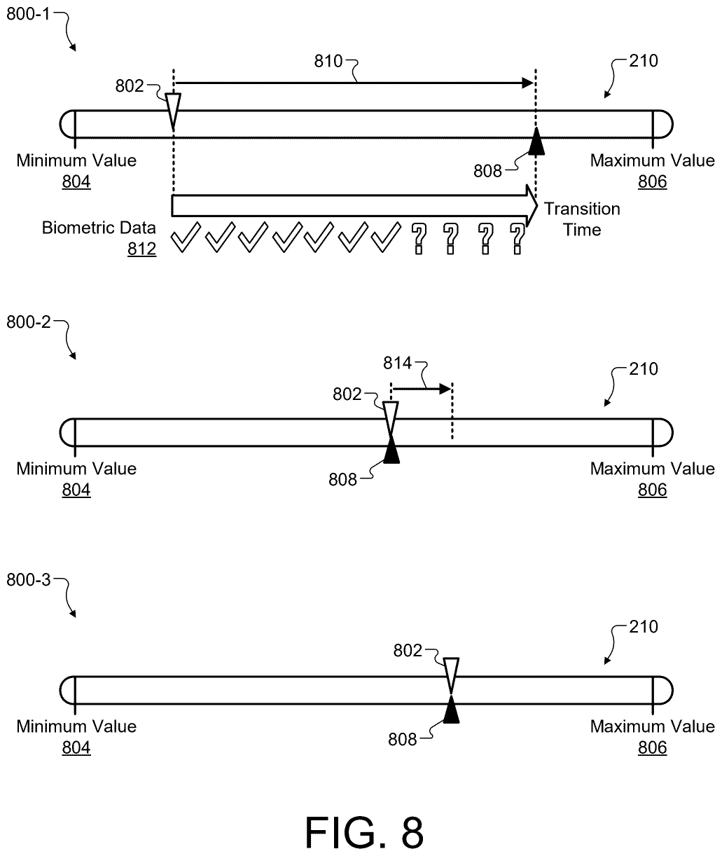

FIG. 8 shows illustrative aspects of how user biometrics and user input may both be used to improve a display management model in accordance with principles described herein.

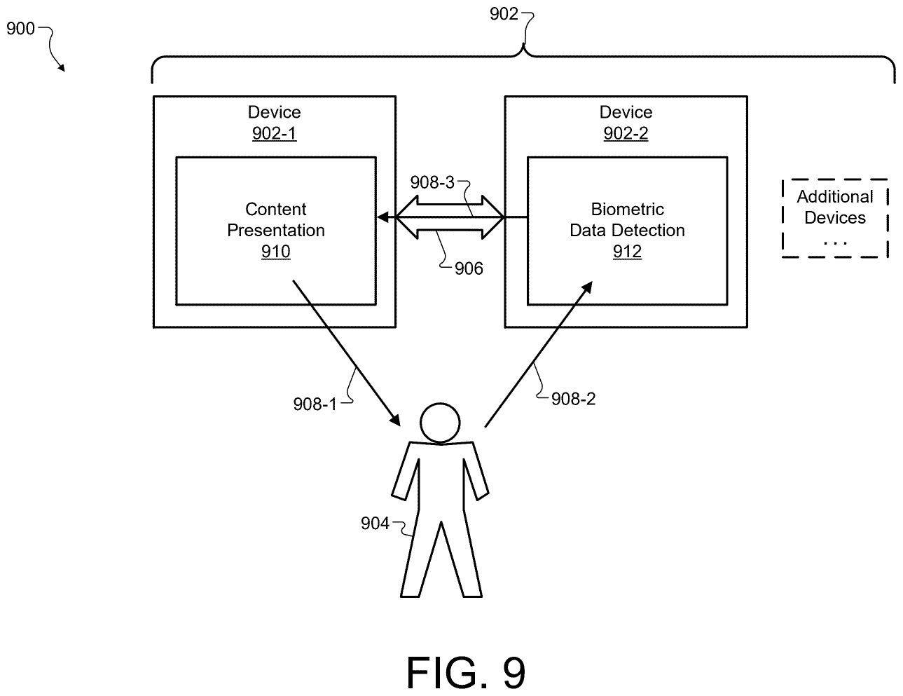

FIG. 9 shows certain aspects of an illustrative implementation of biometric data usage by interconnected devices in accordance with principles described herein.

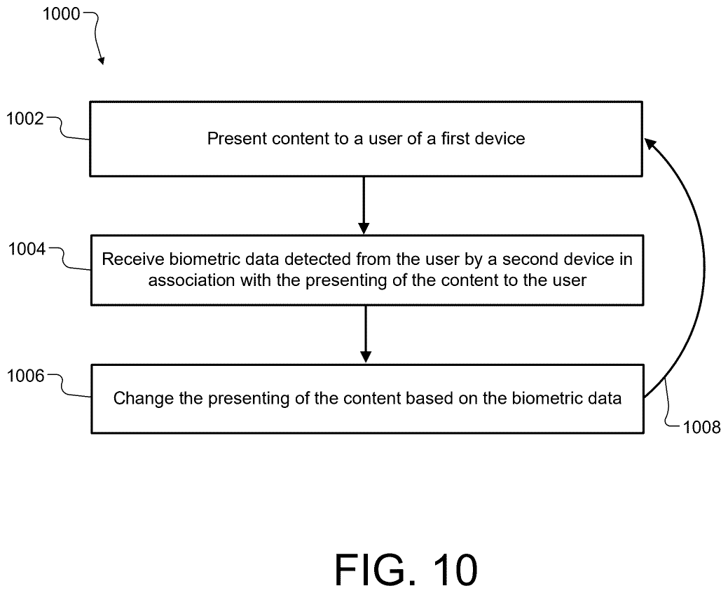

FIG. 10 shows an illustrative method for biometric data usage by interconnected devices in accordance with principles described herein.

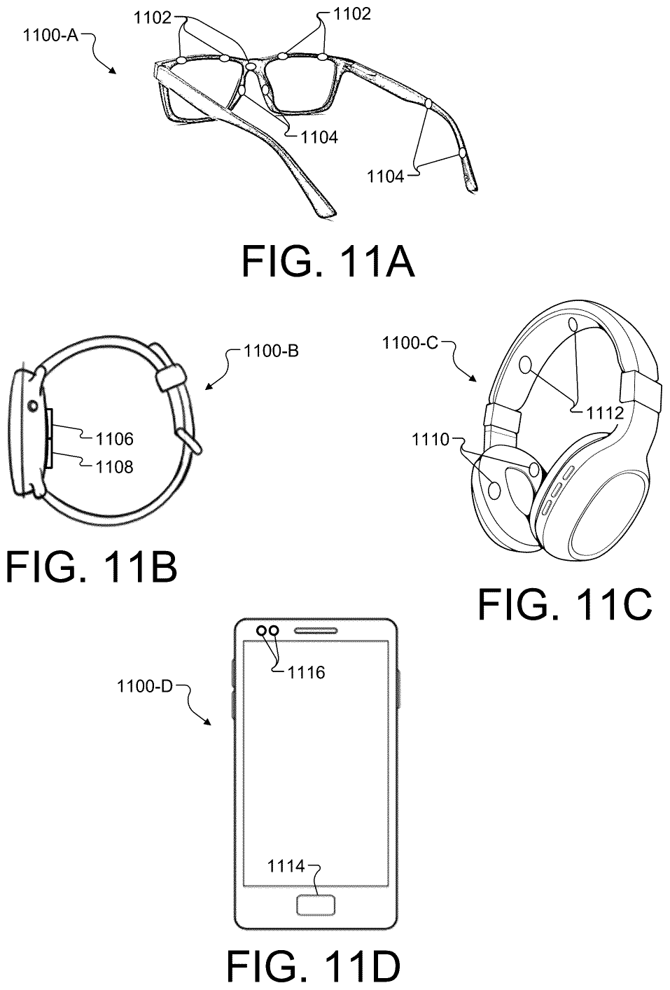

FIGS. 11A-11D show various example devices and how each may be configured with biometric sensors for detecting biometric data to be used by interconnected devices in accordance with principles described herein.

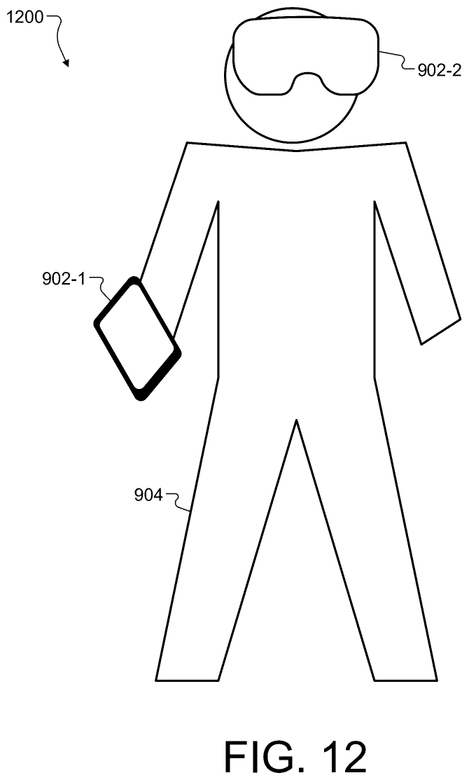

FIG. 12 shows an illustrative scenario for biometric data usage by interconnected devices in which an extended reality presentation device detects biometric data that is used to change a content presentation on a mobile device in accordance with principles described herein.

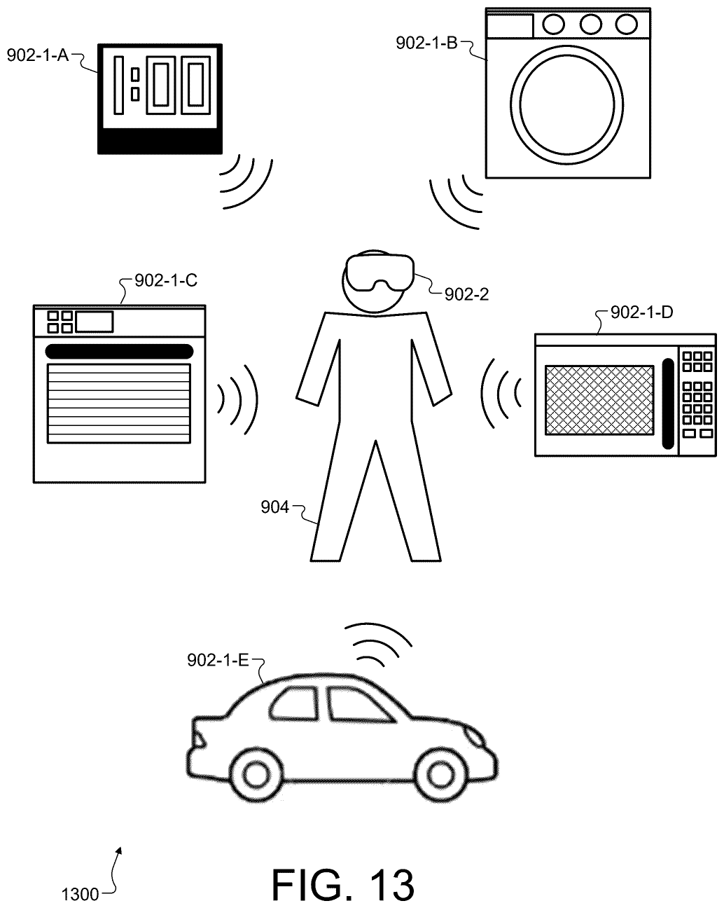

FIG. 13 shows an illustrative scenario for biometric data usage by interconnected devices in which an extended reality presentation device detects biometric data that is used to change various content presentations on appliances and vehicles in accordance with principles described herein.

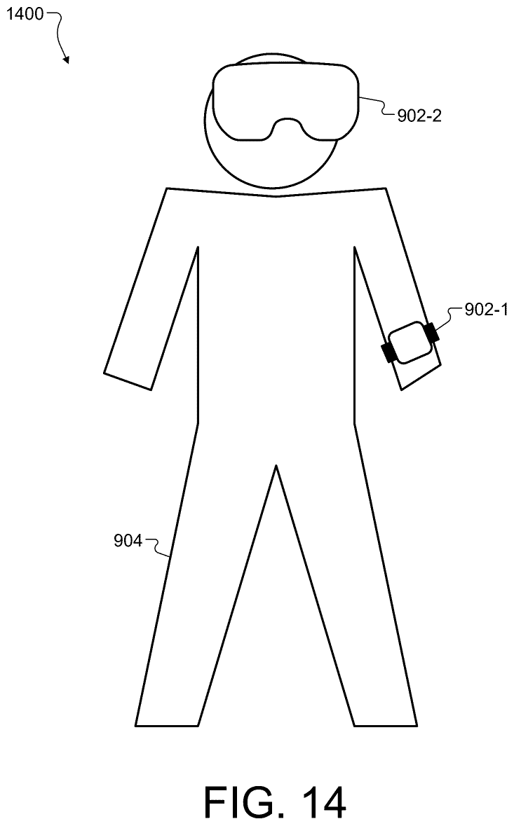

FIG. 14 shows an illustrative scenario for biometric data usage by interconnected devices in which an extended reality presentation device detects biometric data that is used to change a content presentation on a smartwatch device in accordance with principles described herein.

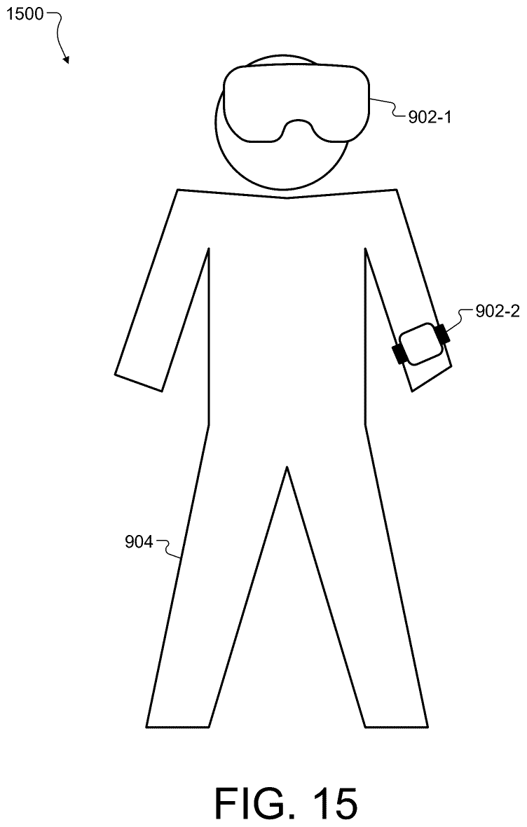

FIG. 15 shows an illustrative scenario for biometric data usage by interconnected devices in which a smartwatch device detects biometric data that is used to change a content presentation on an extended reality presentation device in accordance with principles described herein.

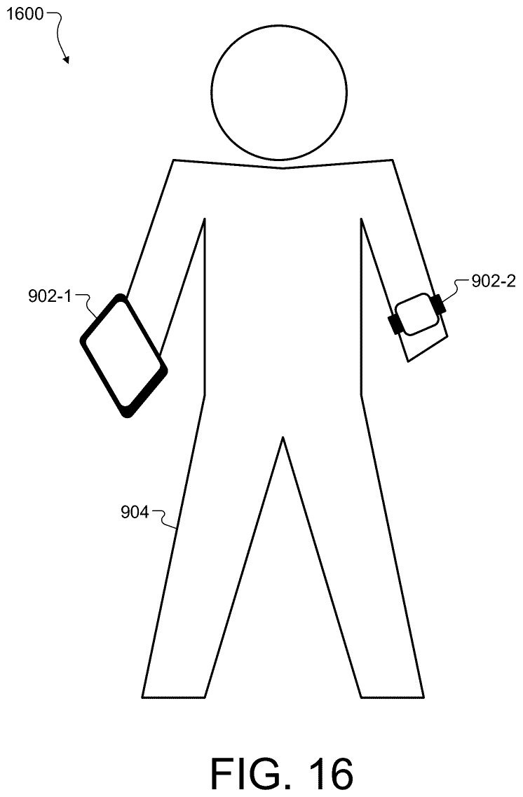

FIG. 16 shows an illustrative scenario for biometric data usage by interconnected devices in which a smartwatch device detects biometric data that is used to change a content presentation on a mobile device in accordance with principles described herein.

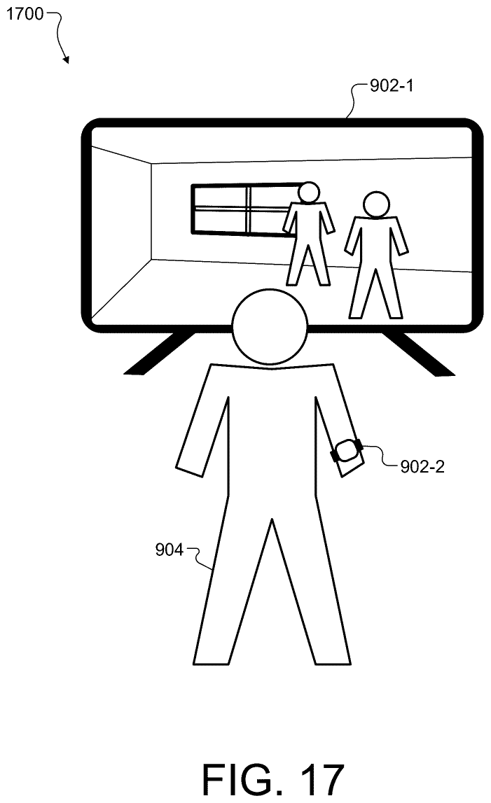

FIG. 17 shows an illustrative scenario for biometric data usage by interconnected devices in which a smartwatch device detects biometric data that is used to change a content presentation on a television in accordance with principles described herein.

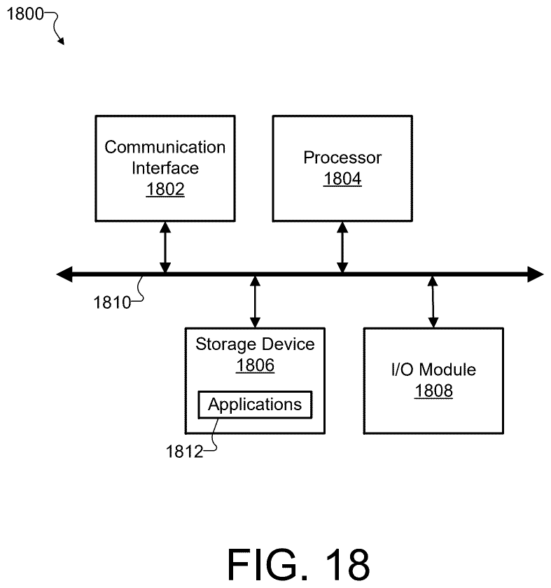

FIG. 18 shows an illustrative computing system that may be used to implement various devices and/or systems described herein.

### DETAILED DESCRIPTION

A variety of devices include displays configured to present visual content (e.g., images, videos, text, etc.) to users of the devices. As one example, extended reality devices employing virtual, augmented, and/or mixed reality technologies may include individual displays positioned before each eye of the user as the user wears a head-mounted display. With extended reality and other display devices alike, it may be desirable to optimize the presentation of visual content for a comfortable and effective user experience in various situations and circumstances. To this end, various types of display management may be performed to control how devices present visual content. For example, display parameters such as display brightness, background tint, video frame rate, image resolution, text attributes (size, color, font, etc.), power usage, and so forth, may all be controlled under certain display management schemes.

Due to battery life, heat, and other such design considerations, it is desirable that displays present content efficiently. For example, if a user is not paying close (or any) attention to a particular presentation of visual content, an efficient device might expend fewer resources on the presentation so as to preserve the resources for when the user is better situated to perceive and appreciate the presentation. The device could dim the display to reduce power consumption when the user's full attention is not on the presentation, for instance, or the device could preserve resources in other ways (e.g., producing the content with less resolution or at a lower refresh rate to reduce processing and memory resources being expended, etc.).

Along with using resources efficiently, it may also be desirable for display devices to present visual content in an optimal manner that may depend on conditions in which the presentation is being given. For example, an electronic display may be easier to see in a relatively dimly-lit context (e.g., an indoor environment) than in a brighter context (e.g., an outdoor environment during daylight hours). As such, certain display parameters of the display device that are optimal in one ambient light context may not be optimal in another ambient light context.

Different types of display devices include one or more displays configured to present visual imagery for various purposes and under various conditions. For example, display devices such as mobile devices (e.g., smartphones, tablets, laptop computers, etc.), televisions, automotive display systems, and various other types of display systems all employ display screens configured to present visual content such as video content or other image or text information. While principles described herein may apply to any of these or various other types of display systems, a particular type of display system will be referred to in the following disclosure to help provide concrete description, illustrations, and examples as these principles are set forth. This particular type of display system is an extended reality display device (e.g., an augmented, virtual, or mixed reality display device) that includes a head-mounted display worn by the user directly in front of their eyes (e.g., a video pass-through display, a heads-up transparent display onto which content is projected or otherwise presented, etc.).

As with various other types of display devices, extended reality head-mounted display devices may include one or more displays configured to present visual content to the user. Such head-mounted displays provide a good example for purposes of the following description at least due to the way that head-mounted displays tend to dominate the user's entire visual field. Unlike devices viewed from a distance (e.g., a television or computer screen) or held at arm's length during operation (e.g., a mobile device such as a phone or tablet), users wearing a head-mounted display may see little or nothing other than what passes through and/or is presented by the head-mounted display. As such, it may be especially desirable for display parameters associated with the head-mounted display device to be optimized to be effective, efficient, and customized to the user in the various contexts in which the device may present the visual content.

Many display devices, including extended reality head-mounted display devices, include user-settable display parameters that allow for various types of display management that may assist with achieving the optimizations described above. For example, displays may operate in accordance with a variety of display parameters governing screen brightness, background tint, text size, and so forth. Other display parameters may also affect the user experience and system efficiency (e.g., power usage, etc.), but may or may not be user-settable. For example, the frame rate, field of view size, pixel resolution, color richness, amount of buffering, and/or other level-of-detail attributes of visual content being presented may be controlled by a display device to similarly enact tradeoffs between system efficiency and quality of service.

Even for display devices that support a significant amount of display management by presenting content in accordance with a variety of user-settable and/or automatic display parameters, certain technical problems arise in practice as users view content presented by the devices in various conditions and situations. First, even if an optimal value for a particular display parameter exists for a particular user and set of circumstances, the user may not be consciously aware of what that value is to be able to set the device accordingly. For example, a user struggling to read text on a see-through display backlit by an environment with a certain intensity and color of ambient light may not know exactly what display parameters they can access to improve the situation or what settings for those display parameters would be most helpful. The user might know, for instance, that the text size can be changed, but may not know that the color and font are also configurable and may be more effective to change under the circumstances. Or the user might be aware that the display brightness and the background tint are each controllable in a device settings menu but may not understand how these parameters relate to one another, such that it is difficult to know whether one or the other or both parameters ought to be altered to improve the situation and make the text more readable.

Additionally, even if the user is well informed about the various display parameters available and is knowledgeable and motivated to try to manage them as different conditions arise, it may still be highly inconvenient to manually and continually adjust the parameters to comport with changing conditions. Indeed, it may be prohibitively inconvenient and distracting for a user to consistently ensure optimal display management in this way. Consequently, even if a device provides good display management possibilities and a user is well-situated to take advantage of these possibilities to effectively manage the viewing experience, there tends to be significant room for improvement both with respect to the display management itself and with respect to the overall user experience. Still other technical problems that may arise with existing display devices include that conventional time-out methods may lead to premature display shutdowns, what is optimal for one user may be suboptimal for other users (e.g., due to differences in age, eyesight, light sensitivity, etc.), and so forth.

Accordingly, display management modeling implementations described herein leverage user biometrics to offer technical solutions to these technical problems and thereby improve the display management and the user experience with the display device. As will be described in more detail below, user biometrics, as referred to herein, refer to various attributes, states, and/or actions of a user that may be performed by the user voluntarily, involuntarily (e.g., subconsciously), or with some other amount of conscious awareness. For example, biometric data associated with voluntary, involuntary (e.g., subconscious), or semi-voluntary eye movements of a given user may be interpreted to indicate various aspects of where the user's attention is directed, what the user is seeing or not seeing, whether the user is awake or asleep, and so forth. As another example, electroencephalography (EEG) and/or electromyography (EMG) data captured from involuntary brain and/or muscle behaviors of the user in response to particular stimuli may indicate whether and when the user registers the stimuli, whether the stimuli cause distress or irritation in the user, and other such data. Other examples of user biometrics could include the user's heart rate, the user's body temperature, the user's oxygen levels, and so forth.

While such biometrics may be conventionally measured to help improve the health and fitness of the user (e.g., by fitness apps, wellness apps, etc.), implementations described herein are not limited to detecting, recording, and reporting on these types of biometric signals. Rather, implementations described herein are configured to use biometric data detected from users to automatically improve the functionality of the device itself, and, in particular, to customize and optimize the display management in real time as a particular user experiences various conditions associated with various contexts.

More particularly, devices and methods described herein perform display management modeling based on user biometrics. For example, a machine learning model may be developed to determine optimal display settings under a variety of conditions. Such a model may then be used to oversee and automatically manage the various display parameters offered by a particular display device. Moreover, while a universal model (e.g., a default model) trained using average preferences of a group of people may be provided to effectively manage the display settings in a way that will provide most users with a high-quality experience, implementations described herein further allow the model to be more finely customized to individual users. For example, a universal default machine learning model may be updated and improved with respect to an individual user's preferences as the user uses the display device and reveals those preferences by both biometric data and explicit user input.

To provide a specific example of how a machine learning model for display management may be used and incrementally improved in accordance with principles described herein, an illustrative display device such as an extended reality head-mounted display will be considered. Upon being provided and used by a user for the first time, the display device may reference a universal default machine learning model that is configured to automatically adjust the values of certain display parameters when a particular situation occurs. For instance, if the user is detected to be reading a white piece of paper within a particular range of ambient light, the universal model may direct a particular display parameter value (e.g., screen brightness, etc.) to be changed from 10 units to 20 units. When this change is made for a particular user, however, a biometric reading from the user (e.g., an EEG, etc.) may indicate that the user becomes uncomfortable with the parameter value after it rises above 16 units. Accordingly, this fact may be incorporated into the model such that the next time this condition occurs, the parameter would only be raised to 16 units (rather than 20 units). Moreover, if other situational factors play in the next time the situation arises (e.g., there is less environmental noise, the user feels more stimulated, etc.), the system may detect that the user manually increases the parameter from 16 units to 18 units. This information, too, could be accounted for in the evolving machine learning model so that the additional factors may also be considered when the conditions reoccur, and the model continues becoming more customized to the user and more effective at determining the optimal settings for various situations.

A variety of technical effects and benefits may result from implementations described herein that provide these types of technical solutions to the technical problems mentioned above. As one example, automatic display management using machine learning models and based on user biometrics may lead to more efficient usage of finite system resources such as battery power used to run display screens of the device. Extended battery life without compromising user experience may advantageously result. Moreover, undesirable device behavior (e.g., premature display shutdowns, displaying of visual content with suboptimal display settings, etc.) may be reduced even as users may maintain as much control as they wish to have over the display management during their experience with the device. Additionally, due to the display management modeling and personalized optimization of display management models described herein, the performance of a display device may incrementally improve for a user the longer the user spends with the device. Ultimately, this improvement may continue until the user consistently enjoys optimal display settings in all situations and is rarely if ever distracted by needing to adjust display parameters or otherwise trouble themselves with display management tasks that the device is performing automatically based on learned preferences of the user.

Moreover, these benefits do not only accrue to users with relatively average attributes and preferences but may also accrue to users with attributes and preferences that may depart significantly from the norm. For example, individuals suffering from conditions that would make communication and manual display management difficult may benefit enormously from biofeedback-driven implementations described herein. Other individuals might have heightened light sensitivity or neurodivergent attributes that cause their preferences and optimal settings to depart significantly from the average. The continual improvement of the machine learning models to increasingly cater to individual users allows these users to develop just as optimized and effective devices as more neurotypical users for whom the universal default machine learning model may be suitable.

Various implementations of display management modeling based on user biometrics will now be described in more detail with reference to FIGS. 1-8. It will be understood that particular implementations described below are provided as non-limiting examples and may be applied in various situations. Additionally, it will be understood that other implementations not explicitly described herein may also fall within the scope of the claims set forth below. Systems and methods described herein for display management modeling based on user biometrics may result in any or all of the technical effects mentioned above, as well as various additional effects and benefits that will be described and/or made apparent below.

FIG. 1 shows certain aspects of an illustrative implementation 100 of display management modeling based on user biometrics in accordance with principles described herein. As shown in the figure, a display device 102 worn by a user 104 is shown at several times T₁-T₄ along a timeline (labeled “Time”). The display device 102 is shown to be in communication with a machine learning model 106 that may be configured to perform display management for display device 102 based on user biometrics from user 104. For example, as will be described in more detail below, the display management may involve determining and automatically setting and adjusting values of various display parameters used by display device 102 to display visual content to user 104. Operations performed by display device 102 at each of the times T₁-T₄ will now be described in more detail to illustrate how the example of implementation 100 achieves display management modeling based on user biometrics.

At time T₁, display device 102 is shown to perform an operation 108-1 in which a display parameter is set to a first value (“Value 1”). While only one display parameter is referenced in FIG. 1 and this description, it will be understood that, in certain implementations, several display parameters may be set in connection with one another and/or at the same time (or close to one another in time). For clarity of description herein, however, a single display parameter is referenced in this and other examples to illustrate the principle without undue complexity being introduced. The display parameter referenced in implementation 100 may be used by display device 102 to display visual content to user 104 and may represent any of the display parameters described herein. As one example, the display parameter may relate to the amount of power used by a display of display device 102 (e.g., a stereoscopic head-mounted display including opaque or see-through screens positioned in front of each eye of user 104). In the same or other examples, the display parameter may govern the brightness of the display, the degree of background tint the display provides, various qualities of image or video content being presented (e.g., resolution, frame rate, field of view, color richness, etc.), or any other aspect of the presentation of visual content by the display.

As used herein, display parameters refer to device settings, characteristics, behaviors, and other such influences on the display of content (as well as on the power and/or other resources that the device may consume while displaying the content). In contrast, values to which display parameters are set refer to specific ways that the display parameters may be configured. For example, the brightness of a display screen may be controlled by a brightness display parameter and a value for this parameter might indicate a numeric value to which the brightness parameter is set (e.g., 200 nits, etc.). As another example, the frame rate with which video is presented may be controlled by a frame rate display parameter that can be set to different numerical values with units of frames per second (e.g., 60 fps, 90 fps, etc.). Accordingly, the value to which a particular display parameter is set (e.g., Value 1 in the example of implementation 100) may be selected to correspond to what the display parameter refers to (e.g., such that the value is an appropriate value in nits for brightness, an appropriate number of frames per second for frame rate, etc.).

The value (“Value 1”) used in operation 108-1 to set the display parameter at time T₁ may be determined using machine learning model 106 in response to an occurrence of a condition associated with a context in which display device 102 displays visual content. While a large number of conditions associated with a variety of contexts may be accounted for by machine learning model 106 (a few of which will be described in more detail below), an example condition for purposes of describing implementation 100 may be that user 104 is looking up at the sky on a bright, sunny day. This condition may call for very different display parameters than, for example, if the user were in a car at night or in an office or some other context. For instance, the bright sky in this example may tend to wash out visual content displayed by display device 102 and make it difficult to see unless the display is very bright and/or includes a relatively dark background tint behind the content being presented.

Once display device 102 identifies this particular condition, machine learning model 106 may help display device 102 determine appropriate settings for the display. For example, operation 108-1 may represent any interactions between display device 102 and any other devices or systems that may be associated with machine learning model 106 that ultimately result in machine learning model 106 determining and setting appropriate values for relevant display parameters of the device. In some examples, machine learning model 106 may be stored and implemented external to display device 102 (e.g., on a cloud server, etc.), such that operation 108-1 may involve communication between display device 102 and the external system. In other implementations, machine learning model 106 may be implemented within display device 102 itself, such that operation 108-1 may represent the internal computations used to determine Value 1 and set the display parameter to Value 1.

In either type of implementation, machine learning model 106 may be initialized with training data 110 that is associated with an average of a plurality of user preferences from a plurality of users 112. For example, a group of users may be assessed in a variety of conditions as part of the initial development of a universal default version of machine learning model 106 that is provided with display device 102 before being personally customized to any specific user. Each of these users 112 may indicate their own preferences in a controlled (e.g., laboratory-type) setting in which their biometrics may be measured with highly accurate equipment (e.g., more accurate sensors than may be available to display device 102) and correlated to their stated preferences. An average (e.g., mean, median, mode, etc.) of these user preferences may then be used to generate training data 110 so that the universal default version of machine learning model 106 may be generated and trained. All of this may occur prior to display device 102 displaying any visual content to user 104. For example, machine learning model 106 may be initially trained based on training data 110 during development of the display device product before it is made available to users such as user 104.

At time T₂, an operation 108-2 is shown to be performed by display device 102 to detect biometric data from user 104 as display device 102 displays the visual content to the user. As used herein, this detection of biometric data may be referred to as being in association with the setting of the display parameter to a particular value (e.g., “Value 1” in this example). This association may take any of several forms. As one example, the biometric data of operation 108-2 may be detected in response to the setting of the display parameter. For instance, after the display parameter is set to Value 1, display device 102 may automatically detect the user's biometric response to this change. As another example, the biometric data of operation 108-2 may be detected in response to the same condition that triggered the setting of the display parameter at operation 108-1. For instance, if the display parameter was set in response to user 104 walking outside or turning to look at the sky, the biometric data detection at operation 108-2 may be triggered by this same condition. As yet another example, the biometric data may be detected during (e.g., repeatedly detected throughout) a transition period when the display parameter is gradually being moved from a previous value to the new value (Value 1 in this example). Detecting the biometric data based on any of these triggers or with any of these timings may be considered detecting the biometric data in association with the setting of the display parameter as that phrase is used herein.

The biometric data detected at operation 108-2 may be any type of biometric data described herein or as may serve a particular implementation. For example, as will be described in more detail below, different types of devices (including a head-mounted extended reality device such as illustrated by display device 102 in implementation 100) may include different types of biometric sensors configured to capture EEGs, EMGs, eye movements, heart rates, body temperatures, and/or other suitable biometrics.

At time T₃, an operation 108-3 may be performed in which the biometric data detected at operation 108-2 is used to update machine learning model 106. In some cases, the biometric data may reflect more or less what the machine learning model would expect. For example, the biometric data detected at time T₂ from user 104 may be, under the current conditions, similar to the average biometric measurement from in the plurality of users 112 during the training process. As another example, if machine learning model 106 has already been updated to reflect detected biometrics of user 104 based on the present conditions and display parameter values, the update associated with operation 108-3 may be minor if the user's reaction is essentially the same as it has been in the past. Conversely, if the biometric data used for the update of operation 108-3 is substantially different from what may already be incorporated within machine learning model 106 (e.g., substantially different from the average biometric measurement from plurality of users 112, substantially different from previous biometric measurements from user 104 under similar circumstances, etc.), then the update of machine learning model 106 at operation 108-3 may be more substantial.

Time T₄ may take place any time after the update of the machine learning model and may correspond to a reoccurrence of the condition under which the visual content was initially displayed using Value 1 of the display parameter at time T₁. For example, if the condition at time T₁ that triggered the change of the display parameter to Value 1 included user 104 looking at a clear sky during the daytime, time T₄ may refer to a reoccurrence of this condition at a later time (e.g., the user again looking at the sky the next day, etc.). Similar to operation 108-1, operation 108-4 shows that display device 102 may set the display parameter for use in displaying visual content to user 104. However, whereas the display parameter was previously set to Value 1, operation 108-4 shows that machine learning model 106 has now been updated (e.g., based on the biometric data detected in association with the previous setting of the display parameter to Value 1), such that operation 108-4 involves setting the display parameter to a second value different from the first value (labeled as “Value 2” in implementation 100).

For example, if the biometric data indicated that Value 1 was slightly uncomfortable for user 104 when it was previously used under the relevant condition, the machine learning model 106 is used to determine a Value 2 that should be more optimal. While not shown in FIG. 1, it will be understood that the process may then continue in which biometric data is detected and the machine learning model is updated. In this way, the model may be incrementally improved over time to become highly tailored to the preferences of user 104 for a variety of different conditions and contexts.

FIG. 2 shows a block diagram of an illustrative display device for display management modeling for different contexts based on user biometrics in accordance with principles described herein. More particularly, similar to display device 102 described above in relation to implementation 100, FIG. 2 shows an augmented reality display device 200 that includes a head-mounted display 202, one or more biometric sensors 204, one or more processors 206, a memory 208 (e.g., a facility for temporary or long-term data storage), and possibly other components not explicitly shown in FIG. 2. Memory 208 is shown to store data for machine learning model 106 and a set of display parameters 210, as well as storing (possibly along with other data not shown) instructions 212 for one or more processes 214 that processors 206 may be configured to perform.

The components of augmented reality display device 200 in FIG. 2 will be understood to be selectively coupled to one another in any manner as may serve to facilitate functions described herein. For instance, the processors 206 may be communicatively coupled to memory 208 to access, use, and/or update machine learning model 106 and display parameters 210. This coupling may also allow processors 206 to load instructions 212 as processes 214 are executed. Similarly, biometric sensors 204 may be communicatively coupled to processors 206 to provide biometric data captured by biometric sensors 204 for processing by processors 206 and storage within memory 208. Head-mounted display 202 may similarly be coupled with processors 206 and may be directed by the processors (as driven by driver circuitry not explicitly shown) to present visual content to user 104. As shown, a content presentation 216 may be delivered by head-mounted display 202 to user 104 and a biometric measurement 218 may be taken by biometric sensors 204 from user 104 in association with augmented reality display device 200 displaying the visual content while user 104 is in a particular context 220. Each of these components will now be described in more detail.

Head-mounted display 202 may be implemented in this example by a head-mounted extended reality display device. For example, the display could be a see-through display of a pair of augmented reality glasses, a heads-up display (e.g., with video pass through) of a mixed reality headset, or any other suitable type of display. In certain examples, much or all of augmented reality display device 200 may be integrated in a single head-mounted chassis, whereas in other examples, the head-mounted display 202 may be a single component of the device that connects to other components by wired or wireless means (e.g., a headset tethered to a computing device carried in the user's pocket or worn on the user's person, etc.). However it is implemented, head-mounted display 202 may be configured to display visual content to user 104 based on display parameters 210.

Biometric sensors 204 may be implemented as any suitable types of sensors configured, when enabled by user 104, to detect any suitable biometric data as may serve a particular implementation. In particular, if biometric sensors 204 are enabled, they may serve to detect user biometrics described herein as head-mounted display 202 displays visual content to the user (e.g., in association with content presentation 216). A few non-limiting examples of biometric data and the sensors that may be configured to detect it will now be described.

As one example, biometric sensors 204 may include an electroencephalography (EEG) sensor configured to detect EEG data. For example, the EEG sensor may include a plurality of electrodes that may be in contact with the user's head when head-mounted display 202 is being worn. Using these electrodes, the EEG sensor may measure brain activity patterns that, when properly processed and interpreted, may be indicative of user attention, state of mind, comfort level, cognitive load, and so forth. For example, EEG readings from user 104 may indicate visual strain (e.g., if the user is trying but struggling to read text being presented, etc.), discomfort (e.g., if the display is brighter than the user prefers under the circumstances), attention (e.g., if the user distracted, if the user has noticed a certain aspect of the content), emotional state (e.g., if the user is content or stressed, etc.), and so forth.

As another example, biometric sensors 204 may include an electromyography (EMG) sensor configured to detect EMG data. For instance, facial expressions of the user may be analyzed by an inward facing camera (e.g., the same or a different camera as one used to detect eye movements) and the expressions may be analyzed to determine and/or confirm the same types of indications described above in relation to EEG sensors. For example, if the screen is uncomfortably bright, the user's facial muscles may wince in a detectable way that indicates the discomfort (or confirms discomfort that is independently inferred from an EEG). As another example, the user's eyes may squint in a detectable way when straining to view text that may be difficult to read. Any of these or other subtle facial muscle movements may be detected and analyzed as physiological indicators of what the user may be experiencing.

As yet another example, biometric sensors 204 may include an eye tracking camera (or a system of eye tracking cameras) configured to detect attention data. For example, eye tracking cameras may be calibrated to determine a gaze direction and/or fixation of the user that may provide further information about where the user's attention is directed. In some examples, stereoscopic eye tracking may allow the device to not only identify the angle of the user's gaze but also determine the depth at which the gaze is focused (e.g., whether the user is looking at something relatively close or something farther away). In this way, accurate attention data indicative of exactly what content the user directs their attention to may be determined. Along with determining attention data associated with the user's gaze (based on the angle and focus depth of the user's eyes as described above), eye tracking sensors may further measure and/or record other useful aspects of the user's vision system such as pupil dilation, blinks, gaze patterns, and so forth. As with the gaze, these aspects offer further real-time insights into how the user's eyes are responding to the current display settings and environment. Additionally, the behavior of the eyes may be used to infer and/or confirm (e.g., increase confidence of) certain aspects of the user's state of mind. For example, by detecting saccades of the eyes, the device may be able to determine that the user may be tired or unengaged (e.g., as evidenced by eyes remaining relatively still), that the user may be anxious or excited (e.g., as evidenced by eyes darting around), that the user may be seeking information and struggling to find it, and so forth.

As yet another example, biometric sensors 204 may include a heart rate sensor configured to detect heart rate data. As one example, a heart rate sensor could use electrocardiograma detect small electrical signals corresponding to a heartbeat of the user. As another example, the heart rate sensor could use optical detection of the pulse such as with photoplethysmography (PPG) technology. In this case, the sensor would use light (e.g., infrared light) shined through the user's skin to detect blood volume changes in the arteries that correspond to heartbeats. In still other examples, PPG could be contactless and could involve a camera (e.g., the same or a different camera as those described above to detect EMG and/or eye tracking biometrics) trained on a particular part of the body (e.g., a forehead, etc.) to detect pulses through rhythmic perturbations on the skin, color changes (as blood volume fluctuates), or the like.

In still other examples, biometric sensors 204 may include other types of sensors such as thermometers configured to detect body temperature data, inertial measurement units (IMUs) configured to detect activity levels (e.g., when the user is sitting still versus on a brisk walk, etc.), fingerprint readers configured to detect user fingerprints, optical face scanners configured to identify facial features and recognize and authenticate particular users, and/or any other biometric sensors as may serve a particular implementation.

Biometric sensors may be located and positioned in a variety of ways depending on how the display device is implemented and the function of the biometric sensors. For example, if augmented reality display device 200 is implemented using augmented reality glasses, electrodes for the EEG sensor could be placed on the temples and nose pads of the glasses (or anywhere else that the glasses contact the user's skin); cameras for the EMG, eye tracking, and/or heart rate sensors could be placed around the rims of the glasses and/or at the endpiece or bridge of the glasses; and so forth. In other examples that do not involve extended reality head-mounted devices, other types of biometric sensors may be placed elsewhere. For example, if the display device is a mobile device such as a smartphone, camera-based sensors could use backwards-facing cameras of the device configured to capture images of the user, heart rate sensors could be configured to detect a pulse in the user's thumb or fingers as they manipulate the device, and so forth.

As further shown in FIG. 2, augmented reality display device 200 is a computing system that includes one or more processors 206 and a memory 208. Processors 206 may represent one or more general purpose processors (e.g., central processing units (CPUs), microprocessors, etc.), one or more special purpose processors (e.g., graphics processing units (GPUs), field programmable gate arrays (FPGAs), application specific integrated circuits (ASICs), etc.), and/or any other processors as may serve a particular implementation. Processors 206 may be communicatively coupled to memory 208 to store data in memory 208 and/or to load data from memory 208. For instance, processors 206 may be used to perform one or more processes 214 by loading, from memory 208, instructions 212 that encode the process. Processors 206 may also access and update machine learning model 106 based on data stored in memory 208 and may manage how head-mounted display 202 displays visual content based on display parameters 210 managed within memory 208.

In the example of FIG. 2, machine learning model 106 is shown within memory 208, where, as mentioned above, it may be accessed and used by processors 206 in the ways described herein. It will be understood that this type of implementation is only an example and that in other examples machine learning model 106 may be implemented elsewhere or in other ways. For instance, rather than storing the model locally within augmented reality display device 200 where processors 206 may use and update the model directly, machine learning model 106 could instead be stored and operated on a separate computing device (e.g., a cloud-based computing device, etc.) and could be queried by augmented reality display device 200. For example, augmented reality display device 200 may provide various outputs that would allow machine learning model 106 to be updated and the external computing device, upon being queried with certain inputs, may provide appropriate outputs (e.g., indicative of display parameters that are to be used, etc.).

Irrespective of where and how it may be implemented, machine learning model 106 may be configured to account for various inputs and to provide a variety of outputs that, over time, tend to become better customized to the user. A few examples of the inputs that may be received by machine learning model 106 include information about the context 220 in which the device is operating (e.g., environmental factors, situational factors, historical factors, etc.), the present state of the user (e.g., as detected by biometric measurements 218 by biometric sensors 204, as maintained in a profile of the user, etc.), current display parameters values, the state of augmented reality display device 200 itself (e.g., which modes it may be operating in, whether user input is being received that could override other inputs, etc.), and so forth.

Based on these and/or other suitable inputs, machine learning model 106 may be configured to determine (or provide output data that assists augmented reality display device 200 in determining) values for display parameters 210. For example, given a particular combination of inputs (also referred to herein as a condition associated with the context 220 in which the device displays visual content), machine learning model 106 may generate outputs that change the mode of head-mounted display 202 (e.g., turn the screen off or on, put the display in a power-saving mode, etc.), outputs that change display parameters such as the brightness or tint of head-mounted display 202, outputs that alter the way text or other visual content is presented (e.g., text size, image resolution or frame rate, etc.), or the like. Several examples of such display management will be illustrated and described in more detail below.

The display parameter values determined by machine learning model 106 may be based on the context 220 in which augmented reality display device 200 displays visual content to user 104 (e.g., by performing content presentation 216). More particularly, the determination of a particular value for a particular display parameter 210 may be performed in response to an occurrence of a particular condition associated with content 220. As described above, context 220 may refer to various aspects of environmental, situational, historical, and/or other circumstances under which user 104 is experiencing the content being presented. As such, conditions that trigger machine learning model 106 to determine appropriate values for certain display parameters 210 may be any suitable conditions that may be detected to occur during a usage session of augmented reality display device 200.

As a first example, the condition in response to which a display parameter value is determined may be an environmental condition. For instance, the environmental condition could be associated with an ambient light context in which the device displays the visual content (e.g., whether the device is used in a bright outdoor environment, a well-lit indoor environment, a dimly-lit indoor environment, a dark environment, an environment where certain light frequencies are emphasized in the ambient light over others, etc.). As another example, the environmental condition could be an ambient sound context in which the device displays the visual content (e.g., whether the device is used in a noisy environment where user 104 may likely be overstimulated or distracted, whether the device is used in a still environment where user 104 is likely to have more capacity to focus and concentrate, etc.). Other suitable environment-related context (e.g., ambient temperature, weather such as wind or rain that may distract the user, etc.) may also be considered. Various sensors not explicitly shown in FIG. 2 (e.g., ambient light sensors, microphones, ambient thermometers, etc.) may be included within augmented reality display device 200 and used to determine these and other suitable environmental conditions.

As another example, the condition in response to which a display parameter value is determined may be a situational condition. For instance, the situational condition could be associated with a state of the user while the device displays the visual content (e.g., whether the user is agitated or calm, anxious or bored; whether the user uses prescription lenses and how good their eyesight is, etc.). As another example, the situational condition could relate to an activity being performed by the user while the device displays the visual content (e.g., whether the user is exerting themselves or remaining relatively still, whether the user is actively engaged with content being presented or more focused on an activity in which they are engaged, what activity the user is engaged with, etc.). Other suitable situation-related context may also be considered, and biometric sensors 204 and other components of augmented reality display device 200 not explicitly shown (e.g., cameras, etc.) may be used to determine situational conditions of context 220 as content presentation 216 is ongoing.

By accounting for all the various situational and environmental conditions that the user may be experiencing as content is presented, machine learning model 106 may determine very different values for display parameters 210 at different times and under different circumstances. For example, when the user is in a noisy and crowded environment with relatively dim lighting, machine learning model 106 may determine display parameter values that correspond to displaying content that is relatively simple and low impact and unlikely to overstimulate the user. The display could be bright to allow the user to clearly see the content, but the tint could be reduced to also allow the user to take in the relative chaos of the scene. Moreover, the content under these conditions could be simplified such that, for example, relatively few lines of text in a large size and easily-readable font are displayed. In contrast, when the user is in a quiet, well-lit environment without other people present, machine learning model 106 may determine display parameter values that correspond to more complex content that might draw more of the user's attention. For example, the tint could be increased and a greater number of lines of smaller text could be presented.

Display parameters 210 may include any display parameters as may serve to influence what head-mounted display 202 displays and how it is displayed for a particular implementation. For instance, display parameters 210 could include a display parameter associated with a power mode in which the device is operating (e.g., full power mode, reduced power mode, etc.), a display parameter associated with an operational state of the device (e.g., a power-on state or a power-off state), a display parameter associated with a brightness at which the device displays the visual content, a display parameter associated with a tint applied by the device as a background to the visual content being displayed (e.g., using one or more electrochromic lenses, etc.), one or more display parameters associated with various aspects of how text within the visual content is displayed by the device (e.g., text size, text font, text color, a number of lines of text presented at once, etc.), and/or any other suitable display parameters as may serve a particular implementation. Various examples of different display parameters 210 will be described and illustrated in more detail below.

Along with machine learning model 106 and display parameters 210, memory 208 may also store instructions 212 that, when executed by processors 206, may implement various processes 214. As one example, a process 214 may include: 1) setting a display parameter 210 to a first value determined using machine learning model 106 in response to an occurrence of a condition associated with context 220 in which head-mounted display 202 displays the visual content to user 104; 2) detecting, in association with the setting of the display parameter to the first value, biometric data from user 104 (e.g., using biometric sensors 204 to perform biometric measurement 218); 3) updating machine learning model 106 based on the biometric data; and 4) setting the display parameter 210 to a second value different from the first value (where the second value is determined using the updated machine learning model 106 in response to a reoccurrence of the condition).

FIG. 3 shows an illustrative method 300 for display management modeling based on user biometrics in accordance with principles described herein. Referring to the augmented reality display device example described above in relation to FIG. 2, method 300 may correspond to one of processes 214 so that the method may be executed by processors 206 of augmented reality display device 200. In other examples, method 300 may be performed (e.g., possibly with modifications) by other types of display devices as have been described.

While method 300 shows one sequence of operations that may be performed by a display device such as augmented reality display device 200, it will be understood that other implementations of method 300 could omit, add to, reorder, and/or modify any of the operations shown in FIG. 3. While operations shown in FIG. 3 are illustrated with arrows suggestive of a sequential order of operation, it will be understood that some of the operations of method 300 may be performed concurrently (e.g., in parallel) with one another. Each of operations of method 300 will now be described in more detail as the operations may be performed by a display device (e.g., augmented reality display device 200) that includes or has access to a display (e.g., head-mounted display 202), a biometric sensor (e.g., biometric sensor 204), a machine learning model (e.g., machine learning model 106), and a processor (e.g., processors 206) configured to perform the operations of the method. Each of these operations will now be described in more detail in relation to FIG. 3, as well as in relation to various examples illustrated in FIGS. 4-8.

At operation 302, the display device may set a display parameter to a first value. For example, the display parameter may be one of display parameters 210 and, as has been described, may be used by the device to display visual content to a user. As has been described, this first value may be determined using a machine learning model such as machine learning model 106. For instance, the machine learning model 106 may determine the value for the display parameter in response to an occurrence of a condition associated with a context in which the device displays the visual content (e.g., any of the situational, environmental, and/or other contexts 220 described above).

FIGS. 4-7 show a few display parameter examples to illustrate. Specifically, FIG. 4 shows a display parameter 210-P (‘P’ for “power”) that is associated with a power mode in which the device is operating, as well as an operational state of the device. FIG. 5 shows a display parameter 210-B (‘B’ for “brightness”) that is associated with a brightness at which the device displays the visual content. FIG. 6 shows a display parameter 210-T (‘T’ for “tint”) that is associated with a tint applied by the device as a background to the visual content being displayed. FIG. 7 shows several display parameters 210-D (‘D’ for “display”) that are associated with various aspects of how text within the visual content is displayed by the device. More particularly, as shown, display parameters 210-D include parameters for a text size (“Text Size”), a text color (“Text Color”), a text font (“Text Font”), a number of lines of text presented at once (“Text Rows”), and could further include other parameters to control other aspects of the text display. It will be understood that the display parameter examples shown in FIGS. 4-7 are given by way of illustration and do not represent all of the display parameters that may be controlled by a given implementation.

In each of the examples of FIGS. 4-7, visual content is indicated to be presented on a display in different ways as different values of the relevant display parameters 210 are applied. Specifically, the left-hand side of each figure shows a first value to which the display parameter is set as part of the performance of operation 302.

Referring to display parameter 210-P in FIG. 4, for example, a value 402-1 configured to put the device in a full power mode (“Full Power”) is shown to be set (illustrated by a triangular pointer pointing to the full power mode rather than the other supported power modes shown in the figure). When this value is set, content 404-1 presented on a display 406 is shown to be presented at a highest level of performance (without any compromise to attempt to save power). In this case, for instance, content 404-1 is shown to be presented at the full frame rate, the full resolution, a full color richness, a highest level of detail, and so forth. As shown by brackets above display parameter 210-P, the full power setting is one of two power modes that are associated with a power-on state 408 for the device. Accordingly, along with being configured to put the device in the full power mode, value 402-1 is further configured to put the device in power-on state 408.

Referring to display parameter 210-B in FIG. 5, a value 502-1 corresponding to a first degree of brightness at which the visual content is to be displayed is shown to be set (illustrated by a triangular pointer positioned along a spectrum from “Bright” to “Dim”). When this value is set, content 504-1 presented on display 406 is shown to be presented at one particular degree of brightness (a full degree of brightness in this example (“Full brightness”)).

Referring to display parameter 210-T in FIG. 6, a value 602-1 corresponding to a first amount of tint that is to be applied as the background to the visual content is shown to be set (illustrated by a triangular pointer positioned along a spectrum from “Dark” to “Light”). When this value is set, content 604 (represented by generic circles that could represent text, images, or other suitable content) is presented on display 406 in front of a background 605-1 with a relatively dark tint that makes it easier to see content 604 and harder to see the environment passing through the display. For example, electrochromic lenses may be used to create a sec-through screen with a controllable amount of tint (allowing a large or small amount of ambient light to pass through the display).

Referring to several display parameters 210-D in FIG. 7, various values 702-S1 (‘S’ for “size”), 702-C1 (‘C’ for “color”), 702-F1 (‘F’ for “font”), 702-R1 (‘R’ for “rows”) corresponding to different text display parameters 210-D are shown to be set (again illustrated by triangular pointers positioned along various spectra or selection choices associated with the different parameters). When this particular combination of values is set, content 704-1 presented on display 406 is shown to include text presented with the indicated characteristics (i.e., R1 rows of text having font F1, color C1, and size S1). For example, three rows of black text in arial 12-point font could be presented on the display in one example of how several display parameters 210-D may be set.

Returning to FIG. 3, at operation 304, the display device may detect biometric data from the user as the device displays the visual content to the user. For example, any of the biometric sensors 204 described above may be used at operation 304 to detect any of the types of biometric data described herein (e.g., EEG, EMG, eye tracking, heart rate, etc.).

In some examples, the detection of biometric data at operation 304 may be performed in association with the setting of the display parameter to the first value at operation 302. This may be performed in any suitable way. For instance, in some cases, the detecting of the biometric data at operation 304 may be performed in association with the setting of the display parameter by being performed subsequent to the setting of the display parameter (i.e., subsequent to completion of operation 302) while the display parameter is set to the first value. As an example, the setting of the display parameter to the first value could include, for instance, setting the screen brightness to 200 nits from a previous value of 150 nits. In this case, operation 304 would be performed to detect the biometric data after the parameter change was complete and the screen brightness had arrived at 200 nits.

In other cases, however, the detecting of the biometric data at operation 304 may be performed in association with the setting of the display parameter by being performed during a transition of the display parameter from a previous value to the first value (e.g., as operation 302 is still ongoing). Referring to the screen brightness example above in which the screen brightness is changed from 150 nits to 200 nits, operation 304 would in this case be performed to detect the biometric data while the screen brightness was ramping up (e.g., while the brightness was between 150 nits and 200 nits as a transition between them was ongoing). As will be further described in an extended example below, capturing several biometric measurements throughout a particular parameter value transition may allow the device to determine at what point a parameter may be changed more than is desirable (e.g., when the biometrics indicate that the user begins to experience discomfort with the ongoing change), such that the machine learning model may continue to be updated and become increasingly customized to the user's specific preferences.

At operation 306, the display device may update the machine learning model based on the biometric data from the user as detected at operation 304. For example, if the biometric measurement is performed subsequent to the setting of the parameter and the biometric measurement indicates that the new settings are still suboptimal in some way, the update at operation 306 may reflect this so that the parameter may be changed more optimally the next time the condition occurs. On the other hand, if biometric measurements are performed during the transition of the parameter value and at some point during the transition begin to indicate a degree of suboptimality, the update at operation 306 may use these to determine how the parameter ought to be changed to be more optimal when the condition reoccurs. A specific extended example of this latter case will be described and illustrated below with reference to FIG. 8.

At operation 308, the display device may set the display parameter to a second value in response to a reoccurrence of the condition. Similar to the first value set at operation 302, the second value may be determined using machine learning model when the particular condition is detected. However, as a consequence of the updating at operation 306, the second value may be determined using the updated machine learning model. As a result, the second value may be different from the first value even though the condition (associated with the context in which the device displays the visual content) is the same.

Referring again to the examples of FIGS. 4-7 to illustrate, one or more examples to the right of each of the displays described above show a second value to which the respective display parameter may be set as part of the performance of operation 308.

Referring to display parameter 210-P in FIG. 4, for example, a value 402-2 configured to put the device in a reduced power mode (“Reduced Power”) is shown to be set, such that content 404-2 presented on display 406 is shown to be presented at a reduced level of performance configured to compromise certain performance aspects to save power. In this case, for instance, content 404-2 is shown to be presented with one or more of a reduced frame rate, a reduced image resolution, a reduced color richness, a reduced level of detail, or the like. As indicated by the brackets, the reduced power mode, like the full power mode, is associated with power-on state 408 for the device. Accordingly, along with being configured to put the device in the reduced power mode, value 402-2 is further configured to put the device in power-on state 408.

As another example of how display parameter 210-P may be set, FIG. 4 also shows, on the right-hand side of the figure, a value 402-3 configured to put the device in an unpowered mode (“No Power”), such that no content 404-3 (represented by a black box “NO CONTENT”) is presented on display 406 and no power is used. As indicated by the brackets described above, the unpowered mode is associated with a power-off state 410 for the device. Accordingly, along with being configured to put the device in the unpowered mode, value 402-3 is further configured to put the device in power-off state 410.

It will be understood that these power modes may be dynamically switched between during a session based on user attention as indicated by the biometric data measured from the user. For example, when the user is focused on the content being presented, the full power mode may be used. If the user is distracted or otherwise not particularly attentive to the content (such that the full level of detail is unlikely to be appreciated and a lower level of detail is unlikely to be noticed), the reduced power mode may be used. If the user is determined to be highly unengaged (e.g., having removed the head-mounted display, having fallen asleep, etc.), the unpowered mode may be used.

Referring to display parameter 210-B in FIG. 5, a value 502-2 corresponding to a second degree of brightness at which the visual content is to be displayed is shown to be set (illustrated by the triangular pointer positioned at a different point along the spectrum from “Bright” to “Dim”). When this new value is set, content 504-2 presented on display 406 is shown to be presented at a different degree of brightness then the full brightness to which value 502-1 corresponds (a reduced brightness in this example (“Reduced brightness”)).

Referring to display parameter 210-T in FIG. 6, a value 602-2 corresponding to a second amount of tint that is to be applied as the background to the visual content is shown to be set (illustrated by a triangular pointer positioned at a different point along the spectrum from “Dark” to “Light”). When this value is set, content 604 is presented on display 406 in front of a background 605-2 with a relatively light tint that may make it easier to see the environment passing through the display.

Referring to display parameters 210-D in FIG. 7, various values 702-S2, 702-C2, 702-F2, and 702-R2 corresponding to modified text display parameters 210-D are shown to be set (again illustrated by triangular pointers positioned along various spectra or selection choices associated with the different parameters). When this new combination of values is set, content 704-2 presented on display 406 is shown to include text presented with the indicated characteristics (i.e., R2 rows of text having font F2, color C2, and size S2). For example, four rows of blue text in century 18-point font could be presented on the display in one example of how several display parameters 210-D may be changed.

Method 300 may, under certain circumstances or in certain implementations, repeat operations 302-308 to continually refine and customize the device performance to the user's preferences. Under other circumstances and/or in other implementations, however, several additional operations 310 may be performed to further refine the machine learning model based on explicit user input (e.g., manual input intended to override automatic settings). Specifically, as shown, these optional operations 310 include an operation 312 in which user input is received, an operation 314 in which the machine learning model is further updated, and an operation 316 in which the display parameter is set to yet another value (e.g., a third value different from the first and second values) determined using the further updated machine learning model. Each of these operations will now be described in more detail with reference to FIG. 3 and further with reference to an example illustrated in FIG. 8.

FIG. 8 shows parameter value changes for an example display parameter 210 for three separate occurrences 800-1, 800-2, and 800-3 of a particular condition. For instance, the condition may be that the user, in a relatively well-lit room, looks at a white sheet of paper with writing on it (e.g., reading a document, a book, a sign, etc.). In each of occurrences 800-1 through 800-3 of the condition, a current value 802 (represented by a white pointer) is shown to be somewhere between a minimum value 804 and a maximum value 806 for the particular display parameter 210. The current value 802 is shown in relation to a determined value 808 (represented by a black pointer), which will be understood to represent the value determined by the machine learning model at that time (though updates to the machine learning model will change its recommendation from occurrence to occurrence, as will be described).

At the time of occurrence 800-1 of the example condition, current value 802 is shown to be at one particular value relatively close to minimum value 804, while the determined value 808 recommended by the machine learning model is shown to be at a greater value closer to maximum value 806. For example, this could be the first occurrence of the condition and determined value 808 may be a universal default value determined based on an average of other users (e.g., based on training data 110 from plurality of users 112 described above). Based on the discrepancy between current value 802 and determined value 808 at the time of occurrence 800-1, a transition 810 from current value 802 to determined value 808 may be performed (indicated by the arrow). This transition could take place, for example, over the course of one second or another suitable amount of time (e.g., a few tens or hundreds of milliseconds, several full seconds, etc.) that will allow the display to change immediately and without undue delay but that also will allow the change to be gradual enough to not be jarring to the user or distracting to the user's experience.

As transition 810 is performed, certain biometric data 812 may be sampled at several points in time. For instance, several EEG measurements per second could be captured during transition 810 to determine if the user's brain registers some amount of discomfort as the value of the display parameter 210 is changed (e.g., to determine if the screen seems too bright as its brightness ramps up, etc.). In FIG. 8, these discrete biometric measurements of biometric data 812 are represented by check marks where no discomfort or other issue is detected and by question marks when the biometric data 812 indicates that the user may be experiencing some discomfort or other undesirable effect (e.g., the screen seeming too bright and causing an EEG to register discomfort, causing the eyes to squint, etc.). For example, as described above in relation to operation 304, the detecting of biometric data 812 in this example is shown to be performed during transition 810 of the display parameter from a previous value (current value 802) to the first value (determined value 808).

While biometric data 812 captured in connection with occurrence 800-1 indicated that the determined value 808 recommended by the machine learning model (e.g., the universal default value) was a bit more than the user may prefer, it will be assumed for this example that the user did not override the display setting but endured the suboptimal setting. For example, if the screen was a little brighter than the user was comfortable with, the user may have just endured it and not bothered to change it in this example. By the time of occurrence 800-2, however, the device may have updated the machine learning model so that determined value 808 is now closer to the maximum brightness before the user experienced the discomfort (i.e., a value associated with the point where the check marks turned into question marks in biometric data 812). Current value 802 is shown to be set to this second value at occurrence 800-2.

Referring back to FIG. 3, operation 312 includes receiving, subsequent to the display parameter being set to this second value, user input indicative of a user preference with respect to the display parameter. Though the condition of the user being in a well-lit room and looking at a white sheet of paper may be the same in both occurrences 800-1 and 800-2, it may be the case that the user's state of mind or other such factors are different. For example, a large amount of noise or other stimulation may have accompanied the user at occurrence 800-1 while the user may be less stimulated (e.g., in a quieter room or in a more subdued mood, etc.) at the time of occurrence 800-2. Accordingly, with occurrence 800-2, the user may not only not feel discomfort at the level of current value 802 but may desire that the display parameter 210 is a little greater still. As illustrated by a transition 814, for example, the user may provide user input to manually change the value from current value 802 to a slightly higher value.

Referring again back to FIG. 3, based on this user input of operation 312, the device may perform operation 314 to further update the machine learning model. For example, the device may consider the fact that the user took time to manually override the setting for this parameter as a strong indicator that, in general, the user prefers the value to be a little greater than the determined value 808 associated with occurrence 800-2. As another example, the machine learning model may be updated to imbue the model with more nuance and distinguish two different conditions (e.g., high noise and low noise) for the situation in which the white paper is viewed in the well-lit room.

At operation 316, the device may therefore set the display parameter to a third value different from the first and second values, the third value being determined using the further updated machine learning model in response to an additional reoccurrence of the condition. In other words, as shown in FIG. 8, a third occurrence 800-3 (the additional reoccurrence) of the condition may be detected and current value 802 is shown to be set to the new determined value 808, which is greater than the determined value 808 of occurrence 800-2 but less than the determined value 808 of occurrence 800-1. By repeating these operations under a variety of conditions and contexts and with respect to a variety of different display parameters, the display device may ultimately come to effectively and automatically perform very accurate and fine-tuned display management customized to the user.

Systems and methods relating to display management modeling based on user biometrics have been described in detail in the preceding portions of this disclosure.

As mentioned above, however, display management modeling is only one of the useful applications that computing devices described herein may have for user biometric data detected from users who consent to and wish to make use of this information.

As another example of how user biometric data may be detected and used in certain applications, systems and methods relating to biometric data usage by interconnected devices will now be described. More specifically, while the preceding description related to ways that one computing device can user biometric data to inform how display screen parameters can be customized and modeled so as to be power-efficient and comfortable for users to view, the following description will focus on ways that interconnected devices (e.g., two interconnected devices or systems of three or more interconnected devices) may perform other useful tasks by sharing biometric data that various devices in the system may measure.

For example, in one scenario, a user at home may use a system of devices that includes a smartwatch (worn on the user's wrist), a smartphone (held in the user's hand), a television (viewed by the user from across the room), and augmented reality glasses (worn on the user's face) that may all be configured to intercommunicate with one another. Some of these devices may be well-situated to detect certain biometric data from the user (assuming that the user has consented to and desires such detection). For example, the smartwatch may be configured to monitor the user's heart rate, while the glasses may be configured to detect eye movements of the user and perform EEG measurements. As the system of devices intercommunicates these types of biometric data, various presentations of content to the user may be controlled or influenced by the biometric data. In particular, biometric data determined by one device could be shared with another device that changes (e.g., starts, ceases, modifies, etc.) a presentation of content by, for instance, beginning to present the content, ceasing presenting the content, modifying the content being presented, changing certain parameters of the presentation, or the like.

To provide a few examples, a notification on the smartphone (e.g., regarding an incoming call) could disappear when eye tracking on the AR glasses shows that the user has read the notification; media content on a television or phone could be paused or turned off when a heart rate measured by the watch indicates that the user has fallen asleep (or when eye tracking on the glasses indicates that the user's attention is diverted to something else); an alarm (e.g., from an alarm clock, from a car security system, etc.) could be silenced when EEG data measured by the glasses indicates that the user has heard and registered the alarm; a watch in a dark movie theater could be dimmed when eye tracking and/or EEG data from augmented reality glasses indicate that the user is not currently viewing the watch (and hence does not want the distracting light associated therewith); and so forth. These and various additional types of examples will be described in more detail below.

As more devices become part of users' lives, intelligent management and coordination of the devices and their various functions can become a technical problem. The objective of devices is generally to make users' lives easier, but the proliferation of devices can instead risk creating hassle and/or inconvenience if the devices are not well coordinated to work together to provide value to users or to at least limit themselves to providing useful functionality to users (rather than overreaching and creating unneeded complexity or burden for the user).

Methods and systems described herein for biometric data usage by interconnected devices helps to provide at least one technical solution to these technical problems. Systems of devices can use certain devices to assess the user's mental and physiological state (at least to some extent based on biometric data that is available) and then share this information with other devices that lack the same insight. In this way, all of the devices can behave in ways that are more sensitive to the user's immediate needs and states of mind. For instance, as indicated in some of the examples listed above, a user may be less annoyed by alarms going off and bright screens in dark places when those things can be mitigated based on a determination of what the user wants and/or is already aware of. The technical effect of this solution is thus that devices can be more responsive and useful to the user in any given mental or physiological state (e.g., mood, state of consciousness, etc.). Additionally, the devices may be less likely to behave in ways that are undesirable or inconvenient to specific users and/or in specific circumstances. Various examples along these lines will be provided and these principles made apparent below.

Various implementations of biometric data usage by interconnected devices will now be described in more detail with reference to FIGS. 9-18. It will be understood that particular implementations described below are provided as non-limiting examples and may be applied in various situations. Additionally, it will be understood that other implementations not explicitly described herein may also fall within the scope of the claims set forth below. Systems and methods described herein for biometric data usage by interconnected devices may result in any or all of the technical effects mentioned above, as well as various additional effects and benefits that will be described and/or made apparent below.

FIG. 9 shows certain aspects of an illustrative implementation 900 of biometric data usage by interconnected devices in accordance with principles described herein. A system of devices 902 in implementation 900 is shown to include a first device 902-1 and a second device 902-2. Additionally, a dashed line box next to device 902-2 indicates that “Additional Devices” may also be part of the system, though additional devices between devices 902-1 and 902-2 are not explicitly shown. Each of the system of devices 902 may be associated with (e.g., used by, owned by, accessible to, etc.) a user 904. Additionally, the devices 902 may be communicatively coupled to one another by way of data networks (e.g., a Wi-Fi network or local area network, etc.) or other types of communicative links (e.g., direct wired links, Bluetooth connections, etc.). In the case of illustrative implementation 900, a wireless communicative link 906 is shown to be established between devices 902-1 and 902-2 for the transmission of data between the devices.

Several arrows 908-1 through 908-3 in FIG. 9 are shown to represent the movement of information between the devices 902 and the user 904 of those devices. More particularly, an arrow 908-1 from a content presentation 910 performed by first device 902-1 extends to user 904 to indicate that device 902-1 may be configured to present content to user 904. Moreover, an arrow 908-2 from user 904 extends to a biometric data detection 912 performed by second device 902-2 to illustrate device 902-2 detecting biometric data from user 904 in association with the content being presented to the user. An arrow 908-3 extending from device 902-2 to device 902-1 then represents a communication (i.e., by way of communicative link 906) in which device 902-2 provides the biometric data to device 902-1 (such that device 902-1 receives the biometric data as it was detected from user 904 in association with the content being presented to the user). As will be described and illustrated in more detail below, the first device 902-1 may be configured, based on the received biometric data (represented by arrow 908-3), to change content presentation 910. In other words, based on the biometric data detected from the user in association with the content being presented, device 902-1 may change how the content is presented to the user (e.g., by ceasing to present the content, by presenting different content, by altering or pausing the content presentation, etc.).

As will be detailed below by way of several specific examples, each of the devices in the system of devices 902 may be implemented as separate devices of different device types. While specific sensors or apparatuses used to measure biometric data may in some sense be referred to as “devices,” it will be understood that device 902-2 would generally be functional beyond the biometric measurement functions that it performs. In other words, device 902-2 may be implemented as one of a smartwatch device worn by user 904, an extended reality presentation device that includes a head-mounted display device (e.g., augmented reality glasses, etc.) worn by user 904, or another such device, rather than by an EEG sensor or pulse detector configured solely for detecting biometric data. Device 902-1 may then be any suitable device that is presenting audio, visual, audiovisual, haptic, or other content of any form that may be influenced or customized based on the biometric state of user 904. To provide a few examples, device 902-1 may be implemented as one of a television watched by the user, a mobile device carried by the user, a vehicle or appliance used by the user (and configured to sound an alarm, etc.), or another suitable device that creates audible, visible, or other sensory stimulus to be experienced by the user. In some examples, device 902-1 could be implemented by the same types of devices described above for device 902-2 and vice versa, since certain devices (as described above in relation to the figures illustrating display management modeling) may be configured both to detect biometric data and to present content to a user.

Content presentation 910 may represent any type of presentation of any suitable content as may serve a particular implementation. For instance, if device 902-1 is implemented by a television, content presentation 910 may represent the presentation of a television show, movie, video game, or other media content by the television. As another example, if device 902-1 is implemented by an appliance such as an oven, content presentation 910 may represent the sounding of an alarm or other indicator (e.g., to indicate that the oven has achieved a desired temperature to which it was preheated) or a timer that has expired (e.g., to indicate that food within the oven has baked for the intended amount of time). Still other types of devices may present audible, visible, haptic, aromatic, or other types of content as appropriate for the function of the device.

Biometric data detection 912 by device 902-2 may represent the measurement or other determination of any type of biometric data described herein (e.g., EEG, ECG, heart rate, eye tracking, facial expression recognition, body temperature, activity level, etc.). The ability of a given device 902-2 to capture a particular type of biometric data may depend on the integration and placement of certain sensing equipment within the device, as will be described and illustrated in more detail below.

FIG. 10 shows an illustrative method 1000 for biometric data usage by interconnected devices in accordance with principles described herein. While method 1000 shows one sequence of operations that may be performed by a device such as device 902-1 (or another display described herein such as augmented reality display device 200), it will be understood that other implementations of method 1000 could omit, add to, reorder, and/or modify any of the operations shown in FIG. 10. While operations 1002-1006 shown in FIG. 10 are illustrated with arrows suggestive of a sequential order of operation, it will be understood that some of the operations of method 1000 may be performed concurrently (e.g., in parallel) with one another. Each of operations 1002-1006 of method 1000 will now be described in more detail as the operations may be performed by a content presentation device (e.g., augmented reality display device 200 or any of the types of devices described above as implementing device 902-1). Each of these operations will now be described in more detail in relation to FIG. 10.

At operation 1002, a first device (e.g., an implementation of device 902-1) may present content to a user. For example, as described and illustrated above in relation to user 904, the user may be a user of the first device, as well as of a second device that is configured to detect biometric data from the user. The content presented to the user at operation 1002 may be any suitable content described herein. For example, the content could be audiovisual media content, such as video content (e.g., a movie, a television show or commercial, a short video streamed from a video service, etc.). In other examples, the content could be audio-only media content (e.g., music content, podcast content, etc.) or other audio that is not generally considered media content, such as an alarm sound, a ringtone, or the like. In still other examples, the content could be visual only or could involve other types of stimulation other than audiovisual stimulation (e.g., such as haptic or olfactory stimulation, etc.).

At operation 1004, the first device may receive biometric data from the second device mentioned above, which may be separate from the first device and also used by the user. The second device may be communicatively coupled to the first device such as described above in relation to communicative link 906 of FIG. 9. The biometric data may be detected from the user by the second device in association with the presenting of the content to the user by the first device. For example, as the user is presented the content at operation 1002 and physiologically reacts (e.g., voluntarily or involuntarily) to the content in a manner reflected in the user's biometric data (e.g., becoming aware of the content, looking at the content, being emotionally or physiologically affected by the content in some way, etc.), the second device may detect the biometric data and report it to the first device. The first device may then associate the biometric data with the content being presented.

At operation 1006, the first device may change the presenting of the content to the user based on the biometric data received at operation 1004. This is illustrated by an arrow 1008 that extends from operation 1006 to operation 1002, where the presenting is performed. As operation 1002 is ongoing, operation 1006 causes a change to how the content is presented. This may cause a change in the user's biometrics being detected at operation 1004, which may, in turn, lead to further change (indicated by arrow 1008) of the presentation at operation 1002. In other words, arrow 1008 shows how each of operations 1002-1006 may lead to one another in a circular pattern that may help ensure, as described above, that the content being presented by the first device remains continually relevant, appropriate, and optimized to the mood, mental state, convenience, and so forth, of the user. As described above, the change of the content presentation performed at operation 1006 may be implemented as any suitable type of change, such as ceasing, pausing, beginning, unpausing, altering, switching out, or otherwise modifying the content being presented (or the way it is being presented).

In some examples, method 1000 may be implemented by a non-transitory computer-readable medium associated with the first device. For example, such a medium (e.g., computer memory, storage, etc.) may store instructions that, when executed, cause a processor of the first device to perform a process implementing method 1000. More particularly, the process may involve presenting content to a user of the first device (as described in relation to operation 1002); receiving, from a second device communicatively coupled to the first device, biometric data detected from the user by the second device in association with the presenting of the content to the user (as described in relation to operation 1004); changing the presenting of the content to the user based on the biometric data (as described in relation to operation 1006); and/or other suitable operations described herein.

As mentioned above, the first device (e.g., device 902-1) performing the operations of presenting content and changing the content based on biometric data received from an interconnected second device may be implemented as a variety of types of devices presenting a variety of types of content to a user. The second device (e.g., device 902-2) may also be implemented by various types of devices (including, in some examples, the same types of devices as may implement the first device) that each are able to detect and report on some type of biometric data from the user.

To illustrate, FIGS. 11A-11D show various example devices and how each may be configured with biometric sensors for detecting biometric data to be used by interconnected devices in accordance with principles described herein. More particularly, FIG. 11A shows a device 1100-A implemented as an extended reality presentation device (i.e., a pair of augmented reality glasses in this example); FIG. 11B shows a device 1100-B implemented as a smartwatch device; FIG. 11C shows a device 1100-C implemented as a headset device; and FIG. 11D shows a device 1100-D implemented as a mobile device (i.e., a smartphone in this example). It will be understood that devices 1100-A through 1100-D are shown by way of example, and that other types of devices (particularly those that a user may directly touch, wear on the body, or otherwise be in proximity to during use) may also be used to detect and provide biometric data in other examples. For example, a smart ring worn on the finger, a car technology system with sensors built into the steering wheel or windshield, computing devices integrated into clothing, shoes, jewelry, or other things the user wears, and so forth, may also be other examples of devices that could perform the role described below for devices 1100-A through 1100-D.

As has been described above in relation to display management modeling using biometric data, various devices may be configured to measure or capture a variety of types of biometric data using a variety of types of sensors integrated within the device. As a few examples, biometric data detected by a device may include EEG data captured by an EEG sensor of a device, eye tracking data based on images of the user captured by a camera of the device, heart rate data captured by a heart rate sensor of the device (e.g., an electrocardiogramalse sensor, a photoplethysmography pulse sensor, etc.), and various other types of data captured by other suitable types of sensors (e.g., body temperature data captured by thermometers, identity data captured by finger and/or optical/facial scanners, etc.).

FIGS. 11A-11D not only show example depictions of the various types of devices 1100-A through 1100-D, but also show, for each class of device, potential placement areas where certain types of biometric sensors could be integrated into the device. While all depicted as small circles for clarity of illustration, it will be understood that the various sensors may have different sizes and shapes as may serve a particular implementation. It will also be understood that, to the extent possible, the sensors may be hidden or made inconspicuous (e.g., for aesthetic and/or functional purposes). The placement locations for the various sensors in FIGS. 11A-11D will be understood to serve only as examples; the same and/or other sensors could also be placed in various other locations in the same and/or other types of devices in certain implementations.

In the glasses device of FIG. 11A, various sensors 1102 are shown to be placed on the inside of the frames of the glasses where the sensors (e.g., eye-tracking cameras in one example) may have a good vantage point on the user's eyes when the glasses are worn. Other sensors 1104 are shown to be placed along the temples and nose pads of the glasses where the sensors (e.g., EEG electrodes in one example) may be able to sense electrical signals (e.g., evoked potentials, etc.) produced by the user's brain in furtherance of EEG readings.

In the smartwatch device of FIG. 11B, different sensors 1106 and 1108 are shown to be placed on the underside of the watch, where they would make contact with the user's wrist when worn. Other sensors (not shown in FIG. 11B) could similarly be integrated into the watch band to serve a similar purpose. These sensors may determine biometric data relating to the user's blood flow. For instance, sensor 1106 could be implemented as an electrocardiogram photoplethysmography pulse sensor such as has been described herein. Sensor 1108 may then represent another type of sensor, such as a thermometer for detecting the user's body temperature, a blood-oxygen sensor for measuring the amount of oxygen in the user's blood, or another suitable biometric sensor as may serve a particular implementation.

In the over-the-car headphone device of FIG. 11C, different sensors 1110 and 1112 are similarly shown to be placed on the device where they may have contact with the user when the headphones are worn. For example, sensors 1110 could be used for determining the user's body temperature or heart rate in similar ways as have been described. Sensors 1112 could then be implemented as EEG or other electrodes configured to read (or to otherwise facilitate measuring) evoked potentials from the brain.

In the mobile device of FIG. 11D, sensors 1114 and 1116 may not be in constant contact with the user's body (as with some other sensors in the other wearable devices). Even still, these sensors may measure or facilitate measurement of certain types of biometric data described herein. For example, sensor 1114 may be integrated into a button that the user periodically presses. Sensor 1114 may detect a fingerprint of the user, a body temperature of the user, a pulse of the user, or some other such biometric information. Sensor 1116 may be implemented by one or more cameras and/or other related components (e.g., a visible light camera and an infrared camera; an infrared camera and an infrared emitter, etc.) that may be configured to detect eye movements and/or facial expressions of the user as the device 1100-D is being used.

Biometric data usage by different combinations of interconnected devices in accordance with principles described herein may be performed in a variety of ways to achieve a variety of functions and effects. To illustrate a few examples more specifically, FIGS. 12-17 each show different illustrative scenarios for biometric data usage by different combinations of interconnected devices. In these scenarios, user 904 is shown with at least two devices that they are using. First, one or more devices labeled as an implementation of device 902-1 will be understood to represent the device presenting the content and changing that content presentation based on received biometric data. Second, a device labeled as an implementation of device 902-2 will be understood to represent the device (such as any of devices 1100-A through 1100-D described above) that detects and provides the biometric data (or provides instructions based on the biometric data) to the device 902-1 as it presents the content.

Since certain devices may be configured to both detect biometric data and present content, the same device may be labeled as a device 902-1 in one of the scenarios of FIGS. 12-17 and as a device 902-2 in another one of the scenarios. However, as the principle being described relates to biometric data usage by interconnected devices, these examples all involve different devices capturing the biometric data and using the biometric data to influence and change how content is presented. Additionally, while each individual example may relate only to one device 902-2 detecting the biometric data, it will be understood that, in certain implementations, systems of devices such as the system of devices 902 may involve multiple devices working in connection with one another to detect and report on various types of biometric data.

As a first illustrative scenario, FIG. 12 shows a scenario 1200 for biometric data usage by interconnected devices in which an extended reality presentation device implementing device 902-2 detects biometric data that is used to change a content presentation on a mobile device implementing device 902-1 in accordance with principles described herein. In other words, in this example, the first device 902-1 is a mobile device carried by user 904, and the second device 902-2 is an extended reality presentation device that includes a head-mounted display device worn by user 904.

Depending on the type of content presented on the mobile device (e.g., smartphone, tablet, e-reader, laptop computer, etc.) implementing device 902-1, the content presentation may be changed in a variety of useful ways when certain types of biometric data are detected and shared by the extended reality presentation device implementing device 902-2.

As a first example, the content presented to user 904 by device 902-1 may include a reminder or message notification. For example, a message notification could indicate a text that has been received, a notification from an app, or the like. Similarly, a reminder set to be presented at a certain time or place may appear (e.g., pop up) in front of other content that the user may be experiencing (e.g., in front of a video being watched, a website being read, etc.). The biometric data detected by device 902-2 may indicate that user 904 perceived the reminder or message notification. For example, eye tracking data may indicate that the user's eyes were directed toward the reminder or message notification for long enough to determine that the user read or at least became aware of the content. As another example, EEG readings may be interpreted to determine that it is likely that the user noticed and became aware of the message content as it appeared, even if their eyes did not necessarily look directly at the content (e.g., since the user may have expected the content). In any case, based on the biometric data, device 902-1 may change the presenting of the content by ceasing presenting the reminder or message notification to user 904. For example, shortly after a pop-up message appears in front of other content being viewed, the message may be automatically dismissed (i.e., may disappear) based on a biometrically-based determination that the user is aware of the information that the message conveyed. In other examples, the ceasing of the presentation may (e.g., based on a user preference setting or certain circumstances attending the situation) snooze the notification, rather than dismissing it outright, so that the message will reappear at a later time.

Similarly, in another example, the content presented to user 904 by device 902-1 may include a ring sequence for an incoming call on device 902-1 (e.g., a phone or other device capable of receiving calls in this example). The ring sequence may include visual elements (e.g., a pop-up message notification), audible elements (e.g., a ringtone), and haptic elements (e.g., vibration). Whatever elements may be included as part of the ring sequence, the biometric data detected by device 902-2 may indicate that user 904 perceived the ring sequence. For example, similarly as described above, eye tracking data or EEG readings could be analyzed to determine that the user is aware of the ring sequence. Facial expression data could further indicate a likelihood that the user perceived the ring sequence (if the facial expression notably changed in connection with the ring sequence, such as detecting a sudden startled expression or an expression of curiosity, etc.). Based on the biometric data, device 902-1 may change the presenting of the content by ceasing the ring sequence, or at least ceasing certain elements thereof (e.g., silencing the audible ringtone, dismissing the visual popup, ceasing the vibration, etc.).

As yet another example, the content presented to user 904 by device 902-1 may include an audible alarm. For example, based on an alarm set previously, the mobile device may sound a ringtone or alarm sound to indicate that the alarm time has been reached. In this case, the biometric data detected by device 902-2 may indicate that user 904 heard the audible alarm. For example, facial expression data could indicate that the user was momentarily startled or annoyed at the sudden alarm sound or EEG readings could be interpreted to determine that the user is aware of the alarm sound. In any case, based on the biometric data, device 902-1 may change the presenting of the content by silencing the audible alarm. For example, under certain circumstances, the alarm could be silenced permanently (e.g., until it is next scheduled to go off). Under other circumstances, the alarm could be snoozed so that it could sound again a few minutes later when circumstances may be different.

In some cases, the content presented to user 904 by device 902-1 may include an audible alarm (such as the alarm described above) presented at a first volume (e.g., a relatively loud volume). When biometric data is detected by device 902-2 to indicate that user 904 heard the audible alarm, device 902-1 may, based on this biometric data, change the presenting of the content by reducing the first volume at which the audible alarm is presented to a second volume lower than the first volume (e.g., a relatively quiet volume). In other words, rather than fully dismissing or snoozing the alarm, the device may, based on a determination that the user is at least likely aware of the alarm sound, reduce the impact (and potentially the irritation factor) of the alarm by reducing the volume. In some examples, the volume change could be performed instead of the snooze or dismissal of the alarm based on a different setting (e.g., if the user has selected to only reduce the volume rather than silence the alarm) or based on a confidence level associated with the biometric data detection (e.g., if the biometric data reveals with a certain probability less than a threshold that the user is aware of the alarm).

As yet another example, the content may be presented to user 904 by device 902-1 on a backlit display screen. For example, the mobile device may present video or other visual content at a certain level of brightness that may be inefficient or undesirable to some extent if the user is not actively viewing the display screen. For example, if the user is in a dark room such as a movie theater, a backlit screen may be distracting and undesirable unless the user is actively trying to read the screen. As another example, if the user is in a brightly lit environment (e.g., outdoors on a sunny day), the display screen may be set to display content at full brightness, which may be wasteful to the battery if the user is not actually looking at the screen. In these types of situations, the biometric data detected by device 902-2 may indicate that the attention of user 904 is not directed to the backlit display screen. For example, eye tracking performed by device 902-2 could indicate that the user's attention is somewhere besides on the backlit display screen of device 902-1 and, based on this biometric data, device 902-1 may change the presenting of the content by either: 1) reducing a brightness of the backlit display screen (e.g., turning down the backlight to save energy and/or make the light less conspicuous), or 2) ceasing presenting the content on the backlit display screen (e.g., temporarily turning off the display screen or at least the backlight).

In some examples, the content presented to user 904 by device 902-1 may include media content (e.g., music, video, etc.). In these situations, the biometric data detected by device 902-2 may indicate that user 904 fell asleep. For example, eye tracking cameras may indicate that the user's eyes are shut while heart rate sensors may indicate that the user's heart rate has slowed and an IMU sensor may indicate that the user's activity level is very low (i.e., they are remaining in one place and not moving much). Based on this biometric data, device 902-1 may change the presenting of the content by: 1) reducing a volume at which the media content is presented, 2) reducing a brightness at which the media content is presented, or 3) ceasing presenting the media content to the user, as may be appropriate under the circumstances (and based on the type of media content being presented).

As another illustrative scenario, FIG. 13 shows a scenario 1300 for biometric data usage by interconnected devices in which an extended reality presentation device implementing device 902-2 detects biometric data that is used to change various types of content presentation on appliances and vehicles implementing device 902-1 in accordance with principles described herein. In other words, in this example, the first device 902-1 is represented by appliances, vehicles, and/or other Internet of Things (IOT) devices that may incorporate embedded computing able to communicate with other devices. For example, these IoT devices may have sufficient computing resources to communicate with the second device 902-2, which is again implemented in this example as an extended reality presentation device that includes a head-mounted display device worn by user 904.

In scenario 1300, a device 902-1-A is shown as a tabletop alarm clock, a device 902-1-B is shown as a clothing dryer, a device 902-1-C is shown as a conventional oven, a device 902-1-D is shown as a microwave oven, and a device 902-1-E is shown as a vehicle (i.e., a car in this example). Each of these devices is shown to be wirelessly connected with the extended reality presentation device implementing device 902-2, such that they may communicate when certain alarms, notifications, or other content is presented and device 902-2 may provide biometric data (or instructions based on the biometric data). While several example devices are illustrated in this scenario, it will be understood that these are examples only and that a number of other types of devices (e.g., IoT-type devices) and other objects incorporating embedded computing resources (e.g., objects not conventionally characterized as computing devices) may similarly be in communication with device 902-2 in certain implementations. For example, principles described below may similarly apply to other appliances (e.g., refrigerators, freezers, washing machines, toasters, etc.), other types of vehicles (e.g., trucks, motorcycles, bicycles, etc.), and other objects (e.g., smart furniture, smart pillows, etc.) capable of presenting various types of content.

Depending on the type of presenting device 902-1 and the content presented thereon (i.e., depending on which of the devices 902-1-A through 902-1-E are involved in a particular example), the content presentation may be changed in a variety of useful ways when certain types of biometric data are detected and shared by the extended reality presentation device implementing device 902-2.

As one example, the content presented to user 904 by the device 902-1 may include an audible alarm, possibly including a visual indicator of the alarm (e.g., a flashing light, etc.). For example, the alarm clock implementing device 902-1-A may be set to sound an alarm at a certain time each day, the dryer implementing device 902-1-B may sound a buzzer when the drying time is complete or the clothes are determined to be dry, the oven implementing device 902-1-C may begin beeping when it is preheated or a timer goes off to indicate that the food is cooked, or the microwave oven implementing device 902-1-D may similarly beep when an assigned cooking task is complete and the food is ready. In any of these cases, biometric data detected by device 902-2 may indicate that user 904 heard the audible alarm and/or otherwise is aware of any audible or visual indications that the appliance is emitting. For example, similarly as described in relation to scenario 1200 above, facial expression data could indicate that the user was momentarily startled or annoyed at an alarm sound, EEG readings could be interpreted to determine that the user is aware of the sound, eye tracking could indicate that the user looked in the direction of the device when the alarm sounded, or the like. Based on the biometric data, each of these devices 902-1-A through 902-1-D may change the presenting of the content by silencing or reducing the volume of the audible alarm and/or otherwise dismissing or snoozing any visual or haptic alarm indicators, similarly as has been described.

In a similar example, the first device 902-1 may be a vehicle used by user 904 (e.g., a vehicle that the user owns and has parked in a parking lot, etc.) that is similarly configured to sound a security alarm. In this example, too, the second device 902-2 may be implemented as the extended reality presentation device with the head-mounted display device worn by the user and the security alarm may be silenced or appropriately reduced in volume based on biometric data detected by the head-mounted display device and other circumstances. For example, if the biometric data indicates that the user is relatively calm but annoyed, the alarm may be assumed to be a false alarm and may be silenced based on the biometric data. Conversely, if the biometric data indicates real distress or fear (e.g., based on an elevated heart rate, certain indicators in EEG data, certain facial expressions, etc.), the alarm may be assumed to indicate an actual problem (e.g., that an intruder is attempting to compromise or damage the vehicle, etc.) and may continue on, possibly with an increase in volume or an escalation in the unpleasantness of the sound, so as to attempt to deter the intruder. In other cases, a device such as the vehicle of device 902-1-E may present and change other types of content that is presented on the dashboard, on an integrated screen, or the like (e.g., while the user is driving or otherwise).

As yet another illustrative scenario, FIG. 14 shows a scenario 1400 for biometric data usage by interconnected devices in which an extended reality presentation device implementing device 902-2 detects the biometric data that is used to change a content presentation on a smartwatch implementing device 902-1 in accordance with principles described herein. In other words, in this example, the first device 902-1 is a smartwatch worn by user 904, and the second device 902-2 is again an extended reality presentation device that includes a head-mounted display device worn by user 904.

Depending on the type of content presented on the smartwatch implementing device 902-1 (e.g., a backlit home screen showing the time, an alarm going off or other sound indicating an incoming call or message notification, etc.), the content presentation may be changed in several useful ways when certain types of biometric data are detected and shared by the extended reality presentation device implementing device 902-2. In general, these ways are similar to ways that have been described above with other types of devices such as the mobile device of scenario 1200 and/or the appliances and vehicle of scenario 1300. However, the form factor and capabilities of the smartwatch implementing device 902-1 in scenario 1400 may create for additional use cases that may provide value in different ways than have been described.

As a first example, the content may be presented to user 904 by device 902-1 on a backlit display screen. For example, the smartwatch may present a home screen with the time or other visual content at a certain level of brightness that may be inefficient or undesirable to some extent if the user is not actively viewing the display screen. Moreover, as mentioned above, if the user is in either a dark or very bright environment, a backlit screen may be either distracting and undesirable or inefficient and wasteful to the battery unless the user is actively looking at the screen. As such, the biometric data detected by device 902-2 may indicate that the attention of user 904 is not directed to the backlit display screen. For example, eye tracking performed by device 902-2 could indicate that the user's attention is somewhere besides on the backlit display screen of device 902-1 and, based on this biometric data, device 902-1 may change the presenting of the content by either: 1) reducing a brightness of the backlit display screen (e.g., turning down the backlight to save energy and/or make the light less conspicuous), or 2) ceasing presenting the content on the backlit display screen (e.g., temporarily turning off the display screen or at least the backlight).

As another example, the content presented to user 904 by device 902-1 may include an audible alarm. For example, based on an alarm set previously, the smartwatch may sound an alarm or noisily vibrate to indicate that the alarm time has been reached. As described above in relation to the mobile phone, the biometric data (e.g., facial expression data, EEG data, etc.) detected in this case could indicate that user 904 heard the audible alarm, and, based on the biometric data, device 902-1 may change the presenting of the content by silencing (e.g., dismissing or snoozing) the alarm on the watch. As further described above, in a scenario where the audible alarm is presented at a first volume (e.g., a relatively loud volume), device 902-1 may, based on the biometric data indicating that the user heard the alarm, change the presenting of the content by reducing the first volume at which the audible alarm is presented to a second volume lower than the first volume.

In yet another example, the content presented to user 904 by device 902-1 may include a ring sequence for an incoming call on device 902-1 (e.g., a call to the smartwatch itself if it is connected to a cellular network, an indication on the smartwatch that an associated phone connected to the watch is receiving a call, etc.). As described in the mobile device example above, the ring sequence may include visual, audible, haptic, and/or other elements and the biometric data detected by device 902-2 (e.g., eye tracking data, EEG data, etc.) may indicate that user 904 perceived the ring sequence. Based on the biometric data, device 902-1 may change the presenting of the content by ceasing the ring sequence or certain elements thereof (e.g., silencing the audible ringtone, dismissing the visual popup, ceasing the vibration, etc.).

In yet another example, the content presented to user 904 by device 902-1 may include a home screen or other content currently active on the smartwatch. Certain smartwatches, in order to conserve battery, may generally operate with the screen turned off and may detect (e.g., based on an orientation of the watch, etc.) when the user wishes to see the watch so that the screen can be enabled. It can be annoying when the watch guesses wrong about the user's intention in either direction, however. For instance, if the user is in a dark room (e.g., the movie theater mentioned above, a room in which they and/or others are trying to sleep during the night, etc.), it may be undesirable for the watch screen to suddenly light up just because the user turned their wrist in a particular direction. On the other hand, if the user is moving regularly (e.g., during exercise, etc.) and actually wants to check the time or other status on the watch (e.g., how many calories they have burned during a workout, etc.), it can also be annoying to look at the watch and see only a black screen. Accordingly, if a device such as device 902-2 can determine biometric data that indicates that the watch's determination to turn the screen on or off is contrary to the user's intent, the biometric data may be provided to allow the watch to change the presenting of the content by doing the opposite (i.e., enabling the screen to present the content if the biometric data indicates that the user is dismayed at it being off, disabling the screen to cease presenting content if the biometric data indicates that the user is dismayed at it being on, etc.).

As yet another illustrative scenario, FIG. 15 shows a scenario 1500 for biometric data usage by interconnected devices in which a smartwatch implementing device 902-2 detects the biometric data that is used to change a content presentation on an extended reality presentation device implementing device 902-1 in accordance with principles described herein. In other words, in this example, the devices of scenario 1400 have switched roles in scenario 1500, making the first device 902-1 an extended reality presentation device that includes a head-mounted display device worn by user 904, and the second device 902-2 a smartwatch worn by user 904.

Depending on the type of content presented on the head-mounted display of the extended reality presentation device implementing device 902-1, the content presentation may be changed in several useful ways when certain types of biometric data are detected and shared by the smartwatch implementing device 902-2. In general, these ways are similar to ways that have been described above with other types of devices. However, the form factor and capabilities of the extended reality presentation device implementing device 902-1 in scenario 1500 may create for additional use cases that may provide value in different ways than have been described. Additionally, two devices that each are capable of detecting biometric data may combine that data to gain new insights or modulate confidence metrics associated with their conclusions, as will be described in more detail below.

As one example, the content presented to user 904 by device 902-1 may include media content (e.g., virtual reality or other immersive media content, music, video, etc.). In these situations, biometric data detected by device 902-2 may indicate that user 904 fell asleep. For example, if the extended reality presentation device does not have heart rate sensors but the smartwatch does, a reduced heart rate reading received from the smartwatch may indicate that the user is likely to be asleep. Even if device 902-1 determines that it is likely that the user is asleep (e.g., based on eye tracking cameras indicating that the user's eyes are shut, etc.) additional confirmatory biometric data from other devices such as device 902-2 may help increase the confidence of device 902-1 in making the determination that the user is sleeping. Conversely, if a confidence metric is low (e.g., based only on the user's eyes being closed for some reason) and heart rate data from the smartwatch indicates that the user is likely active, rather than at rest, this additional biometric data may decrease the confidence metric so that device 902-1 instead determines that the user is not asleep. If the user is determined to be asleep, device 902-1 may, based on the biometric data (e.g., biometric data detected by device 902-1 and/or received from device 902-2), change the presenting of the content in the ways that have been described. For example, device 902-1 may reduce a volume at which the media content is presented, reduce a brightness at which the media content is presented, cease presenting the media content to the user (e.g., pausing or stopping playback), and/or take other actions as may be appropriate under the circumstances (e.g., based on user preferences and/or the type of media content being presented).

As yet another illustrative scenario, FIG. 16 shows a scenario 1600 for biometric data usage by interconnected devices in which a smartwatch implementing device 902-2 detects the biometric data that is used to change a content presentation on a mobile device implementing device 902-1 in accordance with principles described herein. In other words, in this example, the first device 902-1 is a mobile device carried by user 904, and the second device 902-2 is a smartwatch device worn by user 904.

Depending on the type of content presented on the mobile device implementing device 902-1 (e.g., media content, visual notifications, audible alarms, etc.), the content presentation may be changed in several useful ways when certain types of biometric data are detected and shared by the smartwatch device implementing device 902-2. In general, these ways are similar to ways that have been described above, though unique use cases resulting from this new combination of devices may provide value in different ways than have been described.

As a first example, the content presented to user 904 by device 902-1 may include any of the audible alarms, reminders, message notifications, or the like, as have been described (e.g., a ringtone, a song set to play as a wake-up alarm in the morning, an incoming text, a notification from an app, a reminder, etc.). In some examples, these alarms or notifications may be presented in a manner that somewhat interrupts or interferes with other content that the device is presenting, such as by a pop-up or drop-down message appearing in front of (or even replacing) a video that is being watched or an app that is being used. In other examples, the user may not be actively using the mobile device when the content is presented, though the user may hear the content (from their pocket, from the other room, etc.). For example, if the user is sleeping with the smartwatch on, the mobile device could be charging overnight across the room and may sound an alarm in the morning. When the user wakes up from the alarm and their heart rate and/or movement patterns change, biometric data indicative of that may be detected by the smartwatch implementing device 902-2, thereby indicating that user 904 perceived the alarm content. Based on this biometric data, device 902-1 may change the presenting of the content by ceasing presenting the audible alarm or other reminder, message notification, ring sequence, etc., in any of the ways described herein.

As another example, the content presented to user 904 by device 902-1 may include media content (e.g., music, video, etc.) and biometric data detected by device 902-2 (e.g., heart rate data, activity level data, etc.) may indicate that user 904 fell asleep. Here again, based on this biometric data, device 902-1 may change the presenting of the content by reducing a volume at which the media content is presented, reducing a brightness at which the media content is presented, ceasing presenting the media content to the user, or any of the other actions described herein as may be appropriate under the circumstances.

As yet another illustrative scenario, FIG. 17 shows a scenario 1700 for biometric data usage by interconnected devices in which a smartwatch implementing device 902-2 detects biometric data that is used to change a content presentation on a television implementing device 902-1 in accordance with principles described herein. In other words, in this example, the first device 902-1 is a television watched by user 904, and the second device 902-2 is again a smartwatch device worn by user 904.

Given that various types of media content (e.g., movies, video games, TV shows, streamed video content, etc.) are likely to be presented on the television implementing device 902-1, the content presentation may be changed appropriately when certain types of biometric data are detected and shared by the smartwatch device implementing device 902-2. In particular, as one example, the biometric data detected by device 902-2 may indicate that user 904 fell asleep. For example, heart rate sensors may indicate that the user's heart rate has slowed and an IMU sensor may indicate that the user's activity level is very low, as has been described. Based on this biometric data, device 902-1 may change the presenting of the media content in any of the ways as have been described. For instance, the television may reduce a volume at which the media content is presented, reduce a brightness at which the media content is presented, ceasing presenting the media content to the user temporarily (e.g., pausing the content) or more permanently (stopping the content and/or shutting off), or other actions as may be appropriate under the circumstances and based on user preference settings.

As has been mentioned, various methods and processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

FIG. 18 shows an illustrative computing system 1800 that may be used to implement various devices and/or systems described herein. For example, computing system 1800 may include or implement (or partially implement) display devices such as augmented reality display device 200, any implementations thereof or other types of display devices, any components thereof, and/or other devices used therewith. As another example, computing system 1800 may include or implement (or partially implement) any of the implementations of devices 902-1 or 902-2 described above.

As shown in FIG. 18, computing system 1800 may include a communication interface 1802, a processor 1804, a storage device 1806, and an input/output (I/O) module 1808 communicatively connected via a communication infrastructure 1810. While an illustrative computing system 1800 is shown in FIG. 18, the components illustrated in FIG. 18 are not intended to be limiting. Additional or alternative components may be used in other embodiments. Components of computing system 1800 shown in FIG. 18 will now be described in additional detail.

Communication interface 1802 may be configured to communicate with one or more computing devices. Examples of communication interface 1802 include, without limitation, a wired network interface (such as a network interface card), a wireless network interface (such as a wireless network interface card), a modem, an audio/video connection, and any other suitable interface.

Processor 1804 generally represents any type or form of processing unit capable of processing data or interpreting, executing, and/or directing execution of one or more of the instructions, processes, and/or operations described herein. Processor 1804 may direct execution of operations in accordance with one or more applications 1812 or other computer-executable instructions such as may be stored in storage device 1806 or another computer-readable medium.

Storage device 1806 may include one or more data storage media, devices, or configurations and may employ any type, form, and combination of data storage media and/or device. For example, storage device 1806 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1806. For example, data representative of one or more executable applications 1812 configured to direct processor 1804 to perform any of the operations described herein may be stored within storage device 1806. In some examples, data may be arranged in one or more databases residing within storage device 1806.

I/O module 1808 may include one or more I/O modules configured to receive user input and provide user output. One or more I/O modules may be used to receive input for a single virtual experience. I/O module 1808 may include any hardware, firmware, software, or combination thereof supportive of input and output capabilities. For example, I/O module 1808 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1808 is configured to provide graphical data to a display for presentation to a user. The graphical data may be representative of one or more graphical user interfaces and/or any other graphical content as may serve a particular implementation.

The following examples describe implementations of display management modeling based on user biometrics in accordance with principles described herein.

Example 1: A method comprising: setting a display parameter to a first value, the display parameter being used by a device to display visual content to a user, the first value being determined using a machine learning model in response to an occurrence of a condition associated with a context in which the device displays the visual content; detecting, in association with the setting of the display parameter to the first value, biometric data from the user as the device displays the visual content to the user; updating, based on the biometric data from the user, the machine learning model; and setting the display parameter to a second value different from the first value, the second value being determined using the updated machine learning model in response to a reoccurrence of the condition.

Example 2: The method of any of the preceding examples, wherein the biometric data includes electroencephalography (EEG) data detected by an EEG sensor.

Example 3: The method of any of the preceding examples, wherein the biometric data includes attention data detected by an eye tracking camera.

Example 4: The method of any of the preceding examples, wherein the biometric data includes heart rate data detected by a heart rate sensor.

Example 5: The method of any of the preceding examples, wherein: the display parameter is associated with a power mode in which the device is operating; the first value is configured to put the device in a full power mode; and the second value is configured to put the device in a reduced power mode.

Example 6: The method of any of the preceding examples, wherein: the display parameter is associated with an operational state of the device; the first value is configured to put the device in a power-on state; and the second value is configured to put the device in a power-off state.

Example 7: The method of any of the preceding examples, wherein: the display parameter is associated with a brightness at which the device displays the visual content; and the first value and the second value correspond to different degrees of brightness at which the visual content is to be displayed.

Example 8: The method of any of the preceding examples, wherein: the display parameter is associated with a tint applied by the device as a background to the visual content being displayed; and the first value and the second value correspond to different amounts of tint that are to be applied as the background to the visual content.

Example 9: The method of any of the preceding examples, wherein: the display parameter is associated with an aspect of how text within the visual content is displayed by the device, the aspect including at least one of a text size, a text font, a text color, or a number of lines of text presented at once; and the first value is different from the second value so as to cause the aspect of how the text is displayed to change subsequent to the setting of the second value.

Example 10: The method of any of the preceding examples, wherein the condition is an environmental condition associated with at least one of an ambient light context or an ambient sound context in which the device displays the visual content.

Example 11: The method of any of the preceding examples, wherein the condition is a situational condition associated with at least one of a state of the user or an activity being performed by the user while the device displays the visual content.

Example 12: The method of any of the preceding examples, wherein the detecting the biometric data is performed in association with the setting of the display parameter by being performed subsequent to the setting of the display parameter while the display parameter is set to the first value.

Example 13: The method of any of the preceding examples, wherein the detecting the biometric data is performed in association with the setting of the display parameter by being performed during a transition of the display parameter from a previous value to the first value.

Example 14: The method of any of the preceding examples, further comprising: receiving, subsequent to the display parameter being set to the second value, user input indicative of a user preference with respect to the display parameter; further updating, based on the user input, the machine learning model; and setting the display parameter to a third value different from the second value, the third value being determined using the further updated machine learning model in response to an additional reoccurrence of the condition.

Example 15: The method of any of the preceding examples, wherein, prior to the device displaying the visual content to the user, the machine learning model is trained based on training data associated with an average of a plurality of user preferences from a plurality of users.

Example 16: The method of any of the preceding examples, wherein the device is a head-mounted extended reality display device.

Example 17: An extended reality display device comprising: a head-mounted display configured to display visual content to a user based on a display parameter; a biometric sensor configured to detect biometric data from the user as the head-mounted display displays the visual content to the user; a memory storing instructions; and one or more processors configured to execute the instructions to perform a process comprising: setting the display parameter to a first value determined using a machine learning model in response to an occurrence of a condition associated with a context in which the head-mounted display displays the visual content; detecting, in association with the setting of the display parameter to the first value, the biometric data from the user; updating, based on the biometric data, the machine learning model; and setting the display parameter to a second value different from the first value, the second value being determined using the updated machine learning model in response to a reoccurrence of the condition.

Example 18: The device of any of the preceding examples, wherein the biometric sensor is one of: an electroencephalography (EEG) sensor configured to detect EEG data as the biometric data; an eye tracking camera configured to detect attention data as the biometric data; and a heart rate sensor configured to detect heart rate data as the biometric data.

Example 19: A non-transitory computer-readable medium storing instructions that, when executed, cause one or more processors of a device to perform a process comprising: setting a display parameter to a first value, the display parameter being used by the device to display visual content to a user, the first value being determined using a machine learning model in response to an occurrence of a condition associated with a context in which the device displays the visual content; detecting, in association with the setting of the display parameter to the first value, biometric data from the user as the device displays the visual content to the user; updating, based on the biometric data from the user, the machine learning model; and setting the display parameter to a second value different from the first value, the second value being determined using the updated machine learning model in response to a reoccurrence of the condition.

Example 20: The non-transitory computer-readable medium of any of the preceding examples, wherein the process further comprises: receiving, subsequent to the display parameter being set to the second value, user input indicative of a user preference with respect to the display parameter; further updating, based on the user input, the machine learning model; and setting the display parameter to a third value different from the second value, the third value being determined using the further updated machine learning model in response to an additional reoccurrence of the condition.

The following examples describe implementations of biometric data usage by interconnected devices in accordance with principles described herein.

Example 1: A method comprising: presenting, by a first device, content to a user of the first device; receiving, by the first device from a second device communicatively coupled to the first device, biometric data detected from the user by the second device in association with the presenting of the content to the user; and based on the biometric data, changing the presenting of the content to the user by the first device.

Example 2: The method of any of the preceding examples, wherein the biometric data includes electroencephalography (EEG) data captured by an EEG sensor of the second device.

Example 3: The method of any of the preceding examples, wherein the biometric data includes eye tracking data based on images of the user captured by a camera of the second device.

Example 4: The method of any of the preceding examples, wherein the biometric data includes heart rate data captured by a heart rate sensor of the second device.

Example 5: The method of any of the preceding examples, wherein: the content presented to the user includes a reminder or message notification; the biometric data indicates that the user perceived the reminder or message notification; and the changing of the presenting of the content includes ceasing presenting the reminder or message notification to the user.

Example 6: The method of any of the preceding examples, wherein: the content presented to the user includes an audible alarm; the biometric data indicates that the user heard the audible alarm; and the changing of the presenting of the content includes silencing the audible alarm.

Example 7: The method of any of the preceding examples, wherein: the content presented to the user includes an audible alarm presented at a first volume; the biometric data indicates that the user heard the audible alarm; and the changing of the presenting of the content includes reducing the first volume at which the audible alarm is presented to a second volume lower than the first volume.

Example 8: The method of any of the preceding examples, wherein: the content is presented to the user on a backlit display screen of the first device; the biometric data indicates that attention of the user is not directed to the backlit display screen; and the changing of the presenting of the content includes one of: reducing a brightness of the backlit display screen, or ceasing presenting the content on the backlit display screen.

Example 9: The method of any of the preceding examples, wherein: the content presented to the user includes a ring sequence for an incoming phone call on the first device; the biometric data indicates that the user perceived the ring sequence; and the changing of the presenting of the content includes ceasing the ring sequence.

Example 10: The method of any of the preceding examples, wherein: the content presented to the user includes media content; the biometric data indicates that the user fell asleep; and the changing of the presenting of the content includes at least one of: reducing a volume at which the media content is presented, reducing a brightness at which the media content is presented, or ceasing presenting the media content to the user.

Example 11: The method of any of the preceding examples, wherein: the first device is an extended reality presentation device that includes a head-mounted display device worn by the user; and the second device is a smartwatch device worn by the user.

Example 12: The method of any of the preceding examples, wherein: the first device is a television watched by the user; and the second device is a smartwatch device worn by the user.

Example 13: The method of any of the preceding examples, wherein: the first device is a mobile device carried by the user; and the second device is a smartwatch device worn by the user.

Example 14: The method of any of the preceding examples, wherein: the first device is a mobile device carried by the user; and the second device is an extended reality presentation device that includes a head-mounted display device worn by the user.

Example 15: The method of any of the preceding examples, wherein: the first device is a smartwatch device worn by the user; and the second device is an extended reality presentation device that includes a head-mounted display device worn by the user.

Example 16: The method of any of the preceding examples, wherein: the first device is a vehicle or appliance used by the user and configured to sound an alarm; and the second device is an extended reality presentation device that includes a head-mounted display device worn by the user.

Example 17: A system comprising: a first device configured to present content to a user and to receive biometric data detected from the user in association with the content being presented to the user; and a second device communicatively coupled to the first device and configured to detect the biometric data and provide the biometric data to the first device; wherein, based on the received biometric data, the first device is configured to change how the content is presented to the user.

Example 18: The system of any of the preceding examples, wherein: the first device is implemented as one of: a television watched by the user, a mobile device carried by the user, or a vehicle or appliance used by the user and configured to sound an alarm; and the second device is implemented as one of: a smartwatch device worn by the user, or an extended reality presentation device that includes a head-mounted display device worn by the user.

Example 19: A non-transitory computer-readable medium storing instructions that, when executed, cause a processor of a first device to perform a process comprising: presenting content to a user of the first device; receiving, from a second device communicatively coupled to the first device, biometric data detected from the user by the second device in association with the presenting of the content to the user; and changing the presenting of the content to the user based on the biometric data.

Example 20: The non-transitory computer-readable medium of any of the preceding examples, wherein: the content presented to the user includes an audible alarm; the biometric data indicates that the user heard the audible alarm; and the changing of the presenting of the content includes one of: silencing the audible alarm, or reducing a first volume at which the audible alarm is presented to a second volume lower than the first volume.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. A first element could be termed a second element, and, similarly, a second element could be termed a first element, without departing from the scope of the implementations of the disclosure. As used herein, the term and/or includes any and all combinations of one or more of the associated listed items.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “bencath,” “below,” “lower,” “above,” “upper,” and the like, may be used herein for case of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Further to the descriptions above, a user may be provided with controls allowing the user to make an election as to both if and when systems, programs, or features described herein may enable collection of user information (e.g., biometric information described herein, a user's preferences, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, or location information may be obtained (such as to a city, zip code, or state level), so that a particular location of a user cannot be determined. In these and other ways, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A method comprising:
setting a display parameter to a first value, the display parameter being used by a device to display visual content to a user, the first value being determined using a machine learning model in response to an occurrence of a condition associated with a context in which the device displays the visual content;
detecting, in association with the setting of the display parameter to the first value, biometric data from the user as the device displays the visual content to the user;
updating, based on the biometric data from the user, the machine learning model; and
setting the display parameter to a second value different from the first value, the second value being determined using the updated machine learning model in response to a reoccurrence of the condition.

2. The method of claim 1, wherein the biometric data includes electroencephalography (EEG) data detected by an EEG sensor.

3. The method of claim 1, wherein the biometric data includes attention data detected by an eye tracking camera.

4. The method of claim 1, wherein the biometric data includes heart rate data detected by a heart rate sensor.

5. The method of claim 1, wherein:
the display parameter is associated with a power mode in which the device is operating;
the first value is configured to put the device in a full power mode; and
the second value is configured to put the device in a reduced power mode.

6. The method of claim 1, wherein:
the display parameter is associated with an operational state of the device;
the first value is configured to put the device in a power-on state; and
the second value is configured to put the device in a power-off state.

7. The method of claim 1, wherein:
the display parameter is associated with a brightness at which the device displays the visual content; and
the first value and the second value correspond to different degrees of brightness at which the visual content is to be displayed.

8. The method of claim 1, wherein:
the display parameter is associated with a tint applied by the device as a background to the visual content being displayed; and
the first value and the second value correspond to different amounts of tint that are to be applied as the background to the visual content.

9. The method of claim 1, wherein:
the display parameter is associated with an aspect of how text within the visual content is displayed by the device, the aspect including at least one of a text size, a text font, a text color, or a number of lines of text presented at once; and
the first value is different from the second value so as to cause the aspect of how the text is displayed to change subsequent to the setting of the second value.

10. The method of claim 1, wherein the condition is an environmental condition associated with at least one of an ambient light context or an ambient sound context in which the device displays the visual content.

11. The method of claim 1, wherein the condition is a situational condition associated with at least one of a state of the user or an activity being performed by the user while the device displays the visual content.

12. The method of claim 1, wherein the detecting the biometric data is performed in association with the setting of the display parameter by being performed subsequent to the setting of the display parameter while the display parameter is set to the first value.

13. The method of claim 1, wherein the detecting the biometric data is performed in association with the setting of the display parameter by being performed during a transition of the display parameter from a previous value to the first value.

14. The method of claim 1, further comprising:
receiving, subsequent to the display parameter being set to the second value, user input indicative of a user preference with respect to the display parameter;
further updating, based on the user input, the machine learning model; and
setting the display parameter to a third value different from the second value, the third value being determined using the further updated machine learning model in response to an additional reoccurrence of the condition.

15. The method of claim 1, wherein, prior to the device displaying the visual content to the user, the machine learning model is trained based on training data associated with an average of a plurality of user preferences from a plurality of users.

16. The method of claim 1, wherein the device is a head-mounted extended reality display device.

17. An extended reality display device comprising:
a head-mounted display configured to display visual content to a user based on a display parameter;
a biometric sensor configured to detect biometric data from the user as the head-mounted display displays the visual content to the user;
a memory storing instructions; and
one or more processors configured to execute the instructions to perform a process comprising:
setting the display parameter to a first value determined using a machine learning model in response to an occurrence of a condition associated with a context in which the head-mounted display displays the visual content;
detecting, in association with the setting of the display parameter to the first value, the biometric data from the user;
updating, based on the biometric data, the machine learning model; and
setting the display parameter to a second value different from the first value, the second value being determined using the updated machine learning model in response to a reoccurrence of the condition.

18. The device of claim 17, wherein the biometric sensor is one of:
an electroencephalography (EEG) sensor configured to detect EEG data as the biometric data;
an eye tracking camera configured to detect attention data as the biometric data; and
a heart rate sensor configured to detect heart rate data as the biometric data.

19. A non-transitory computer-readable medium storing instructions that, when executed, cause one or more processors of a device to perform a process comprising:
setting a display parameter to a first value, the display parameter being used by the device to display visual content to a user, the first value being determined using a machine learning model in response to an occurrence of a condition associated with a context in which the device displays the visual content;
detecting, in association with the setting of the display parameter to the first value, biometric data from the user as the device displays the visual content to the user;
updating, based on the biometric data from the user, the machine learning model; and
setting the display parameter to a second value different from the first value, the second value being determined using the updated machine learning model in response to a reoccurrence of the condition.

20. The non-transitory computer-readable medium of claim 19, wherein the process further comprises:
receiving, subsequent to the display parameter being set to the second value, user input indicative of a user preference with respect to the display parameter;
further updating, based on the user input, the machine learning model; and
setting the display parameter to a third value different from the second value, the third value being determined using the further updated machine learning model in response to an additional reoccurrence of the condition.
